(19) United States
(12) Patent Application Publication
(10) Pub. No.: US 2007/0044450 A1
(43) Pub. Date: Mar. 1, 2007

(54) Powder propellant-based space propulsion device

(76) Inventor: Hitoshi Kuninaka, Sagamihara-shi (JP)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/431,452

(22) Filed: May 9, 2006

(30) Foreign Application Priority Data
May 9, 2005 (JP) 2005-136531

(51) Int. Cl. F02K 9/68

(52) U.S. Cl. 60/200.1

(57) ABSTRACT

Disclosed is a powder propellant-based space propulsion device using a powder propellant having high density and excellent handleability. The powder propellant-based space propulsion device comprises a powder-propellant storage container for storing a powder propellant, a powder-propellant attracting surface for attracting the powder propellant thereto through an opening of the powder-propellant storage container and attractively holding the attracted powder propellant thereon, powder-propellant transfer means for transferring the held powder propellant to a release position for releasing the powder propellant, and propulsive-energy supply means for energizing the transferred powder propellant to release the powder propellant from the powder-propellant attracting surface, toward a downstream side thereof as a propulsive jet, while accelerating the powder propellant in a direction approximately perpendicular to the powder-propellant attracting surface at said release position. The powder-propellant transfer means is designed to move the powder-propellant attracting surface in such a manner that a powder-propellant holding area of the powder-propellant attracting surface is returned to a position adjacent to the opening of the powder-propellant storage container in a repetitive manner.

### CROSS-REFERENCE TO OTHER APPLICATIONS

The present patent application claims priority from Japanese Patent Application No. 2005-136531, filed on May 9, 2005.

### TECHNICAL FIELD

The present invention relates to a space propulsion device, and more specifically to a powder propellant-based space propulsion device using a powder propellant in such a manner as to be supplied on a portion-by-portion basis without using a working fluid in combination.

### BACKGROUND ART

Heretofore, fuels or propellants in gaseous, liquid and solid forms have been used for space propulsion units. In a general way, a gaseous propellant is highly pressurized and stored in a highly dense state, because the gaseous propellant under natural conditions requires a relatively large container volume. Thus, a storage container (tank) and associated components, such as pipes and valves, are essentially designed to have sufficient pressure resistance and structural strength to withstand such a high pressure. This causes a problem about increase in weight. Moreover, the high pressure is highly likely to cause failures, such as gas leakage from the valve or locking of the valve. A liquid propellant needs to use a high-pressure transfer system even though it originally has a high density, and therefore involves the same problem as that in the gaseous propellant. Further, a thruster using a high-pressure system has a problem about the need for performing a propellant-charging operation as a hazardous job before launch. A solid propellant originally has a high density, and exhibits excellent storage performance without the need for a high-pressure system. On the other hand, the solid propellant has a problem that, once ignited, a propulsive action cannot be stopped until being completely consumed, and a thrust cannot be on/off-controlled or adjusted. An explosive serving as the solid fuel is a flammable material subject to a fire ban in handling, and therefore has poor handleability on the ground. With a view to improving such disadvantages of the solid fuel, there have been made researches on a technique for storing a solid fuel in the form of a plurality of pieces divided on the basis of a volume required for each combustion, and igniting each of the pieces according to need (see, for example, the following Non-Patent Publication 1). However, this technique has a disadvantage that the sold fuel occupies a relatively large area depending on a required number of combustions.

A small-size thruster having difficulty in obtaining a high specific thrust (or specific impulse) needs a larger volume of propellant to generate a required ΔV. A weight of a section for storing a propellant is apt to increase in proportion to a volume of the propellant. Thus, it is important for a small-size thruster to reduce a dry weight of thruster components other than a fuel. In view of the above technical background, there has been proposed a device designed to emit a laser beam onto a solid propellant applied on a surface of a film so as to generate an ablation jet (see, for example, the following Patent Publication 1). A technique of emitting a laser beam from a back surface of the film as disclosed in the Patent Publication 1 can prevent a body and optics system of a laser device from being contaminated by jet substances, and has a certain level of effectiveness in this point. On the other hand, this device has a disadvantage of causing an increase in dry weight of a propulsion unit, because a weight of the film will increase in proportion to a volume of the propellant, and the increased weight of the film will be included in a weight of the propellant storage section despite of no contribution to thrust.

In the device disclosed in the Patent Publication 1, no nozzle is used for ablation jets, and therefore it is difficult to effectively generate a thrust. Moreover, a vaporized propellant is likely to spread and re-solidify, resulting in causing contamination of surroundings. In a space satellite designed to accurately adjust infrared characteristics on a surface thereof so as to control a temperature of the surface, a surface contamination causes serious evils. Thus, the above phenomenon is a critical problem.

As a solid propellant-based propulsion device utilizing no chemical reaction, there has been known one type, so-called “pulsed plasma thruster (PPT)” (see, for example, the following Patent Publication 2). While various materials have been tried as a solid propellant, PTFE (Polytetrafluoroethylene (Teflon®)) is commonly used (see, for example, the following Non-Patent Publication 2). This thruster has a disadvantage that a specific thrust cannot be desirably improved due to sublimated gas to be generated with a delay after completion of a pulsed discharge. Thus, a propellant is limited to a specific type having a low level of delayed gas generation. As other technological developments, efforts have been made for a technique of using a liquid propellant (see, for example, the following Non-Patent Publication 3), and a technique of controlling a sublimation quantity based on laser ablation (see, for example, the following Non-Patent Publication 4). A powder (fine particles) is a high-density solid having a feature of having no need to use a high-pressure transfer system. If such a powder propellant is supplied to a release position on a portion-by-portion basis in a required volume, a propellant volume can be accurately managed to achieve enhanced specific thrust. As to powder propellants, while there has been proposed a technique of transferring a powder propellant in a weightless environment in space (see, for example, the following Patent Publication 3), this technique is not adapted to transfer a powder propellant on a portion-by-portion basis in a required volume.

There has also been proposed a technique of transferring a powder propellant after being mixed with gas (see, for example, the following Non-Patent Publication 5). Although this technique is designed to transfer a powder fuel after being mixed with gas and then produce combustion thereof, so as to allow the powder propellant to be transferred in a required amount, the use of gas causes the aforementioned problem involved in a gas propellant. While it is also contemplated to transfer a powder propellant after being mixed with liquid, this technique will have the aforementioned problem involved in a liquid propellant. That is, even if a powder propellant is transferred using a working fluid, such as gas or liquid, in combination, these techniques will have the same problems as those described above.

[Patent Publication 1] U.S. Pat. No. 6,530,212

[Patent Publication 2] U.S. Patent Application Publication No. 2003/0,033,797

[Patent Publication 3] JP 11-334840 A

[Non-Patent Publication 1] S. Tanaka, R. Hosokawa, S. Tokudome, K. Hori, H. Saito, M. Watanabe and M. Esaka, “MEMS-based Solid Propellant Rocket Array Thruster”, ISTS 2002-a-02, Proceedings of the 23 International Symposium on Space Technology and Science, Matsue, 2002, pp. 6-11.

[Non-Patent Publication 2] H. Kamhawi, E. Pencil and T. Haag, “High Thrust-to-Power Rectangular Pulsed Plasma Thruster”, AIAA 2002-3975, Joint Propulsion Conference, Indianapolis, July 2002.

[Non-Patent Publication 3] A. Kakami, H. Koizumi and K. Komusasaki, “Performance Study on Liquid Propellant Pulsed Plasma Thruster”, AIAA 2003-5021, Joint Propulsion Conference, Huntsville, July 2003.

[Non-Patent Publication 4] M. Kawakami, W. Lin, A. Igari, H. Horisawa and I. Kimura, “Plasma Behaviors in a Laser-Assisted Plasma Thruster”, AIAA 2003-5028, Joint Propulsion Conference, Huntsville, July 2003.

[Non-Patent Publication 5] Akiba, Kono, Yamashita, “Experimental Tests and Researches on Powder Rocket System”, Journal of the Japan Society for Aeronautical and Space Sciences, Vol. 22, No. 246, July/1974.

### DISCLOSURE OF THE INVENTION

As mentioned above, various attempts have been made for allowing solid and powder propellants having a high density, no need for a high-pressure storage/transfer system, and high handleability, to be used in a space thruster propulsion device, all of the conventional techniques have disadvantages, such as an increase in weight of the propulsion device, a surface contamination and restrictions in improving a specific thrust, or have a bunch of problems. In view of the above problems, it is an object of the present invention to provide a powder propellant-based space propulsion device capable of supplying a powder propellant on a portion-by-portion basis.

In the invention defined in claim 3, the accelerating electrode serving as the propulsive-energy supply means includes a first electrode disposed adjacent to the back side of the powder-propellant attracting surface and designed to be applied with a potential having the same polarity as that of the electric charge of the charged powder propellant, and a lattice-shaped second electrode disposed on the downstream side of the release position and designed to be applied with a potential having an opposite polarity to that of the first electrode.

As defined in claim 4, the present invention also provides a powder propellant-based space propulsion device comprising a first powder propellant-based space propulsion sub-device and a second powder propellant-based space propulsion sub-device, each of which incorporates the powder propellant-based space propulsion device as defined in claim 1. In this powder propellant-based space propulsion device, the first powder propellant-based space propulsion sub-device includes first powder-propellant charging means for electrostatically charging the powder propellant to have a positive electric charge, and the second powder propellant-based space propulsion sub-device includes second powder-propellant charging means for electrostatically charging the powder propellant to have a negative electric charge. The first powder propellant-based space propulsion sub-device and the second powder propellant-based space propulsion sub-device are disposed adjacent to one another in such a manner that respective propulsive jets of the first and second powder propellant-based space propulsion sub-devices are oriented in substantially the same direction. Further, the propulsive-energy supply means included in the first powder propellant-based space propulsion sub-device is composed of a first accelerating electrode designed to apply a first accelerating electric field to a powder-propellant accelerating zone starting from the release position, so as to allow the powder propellant positively charged by the first powder-propellant charging means to be accelerated toward a downstream side of the first accelerating electrode by an electrostatic attraction of the first accelerating electric field, and the propulsive-energy supply means included in the second powder propellant-based space propulsion sub-device is composed of a second accelerating electrode designed to apply a

The above object is achieved by the present invention having the following features. Specifically, as defined in claim 1, the present invention provides a powder propellant-based space propulsion device which comprises: a powder-propellant storage container having an inner space for storing a powder propellant and an opening for feeding the powder propellant to the outside therethrough; a powder-propellant attracting surface for attracting the powder propellant in the powder-propellant storage container thereto through the opening and attractively holding the attracted powder propellant thereon; powder-propellant transfer means for moving the powder-propellant attracting surface having a area for attractively holding the powder propellant thereon so as to transfer the powder propellant attractively held on the area to a release position for releasing the powder propellant; and propulsive-energy supply means for energizing the powder propellant transferred to the release position to release the powder propellant from the powder-propellant attracting surface, toward a downstream side thereof as a propulsive jet, while accelerating the powder propellant in a direction approximately perpendicular to the powder-propellant attracting surface at the release position. In this powder propellant-based space propulsion device, the powder-propellant transfer means is designed to move the powder-propellant attracting surface in such a manner that the area for attractively holding the powder propellant is returned to a position adjacent to the opening of the powder-propellant storage container in a repetitive manner.

In the invention defined in claim 2, the powder propellant-based space propulsion device further comprises: powder-propellant charging means for electrostatically charging the powder propellant to have a positive electric charge; and a neutralizer disposed on a downstream side of the release position and designed to emit an electron for neutralizing the electric charge of the powder propellant released as the propulsive jet. In this case, the propulsive-energy supply means is composed of an accelerating electrode designed to apply an accelerating electric field to a powder-propellant accelerating zone starting from the release position, so as to allow the powder propellant electrostatically charged by the powder-propellant charging means to be accelerated toward the downstream side by an electrostatic attraction of the accelerating electric field.

second accelerating electric field to a powder-propellant accelerating zone starting from the release position, so as to allow the powder propellant negatively charged by the second powder-propellant charging means to be accelerated toward a downstream side of the second accelerating electrode by an electrostatic attraction of the second accelerating electric field. The first and second powder propellant-based space propulsion sub-devices are designed such that the positively-charged powder propellant of the first powder propellant-based space propulsion sub-device and the negatively-charged powder propellant of the second powder propellant-based space propulsion sub-device are released therefrom at the same absolute value of electric charge per unit time, and then neutralized in a mixed manner. In the invention defined in claim 5, the powder propellant-based space propulsion device further comprises a tube-shaped jet member having an upstream end for introducing the propulsive jet generated at the release position and a downstream end for expelling the introduced propulsive jet. The upstream end of the jet member is disposed adjacent to the powder-propellant attracting surface. In this case, the release position is defined within a area of the powder-propellant attracting surface surrounded by the upstream end of the jet member. In the invention defined in claim 6, the jet member is formed as a divergent nozzle.

In the invention defined in claim 7, the powder-propellant attracting surface is made of an electrically insulating material. In this case, the powder propellant-based space propulsion device further comprises powder-propellant-attracting-surface charging means for electrostatically charging the powder-propellant attracting surface. The powder-propellant-attracting-surface charging means is operable to allow the powder propellant in powder-propellant storage container to be attracted to the powder-propellant attracting surface through the opening and held on the powder-propellant attracting surface by an electrostatic attraction.

In the invention defined in claim 8, the powder-propellant-attracting-surface charging means is composed of a charge roller disposed in contact with the powder-propellant attracting surface.

In the invention defined in claim 9, the powder-propellant attracting surface is made of a ferromagnetic material. In this case, the powder propellant-based space propulsion device further comprises an attracting magnet for providing a magnetic field at least in a area ranging from an attraction position (adsorption position) where the powder propellant is to be attracted to the powder-propellant attracting surface, to the release position. The attracting magnet is operable to allow the powder propellant in powder-propellant storage container to be attracted to the powder-propellant attracting surface through the opening and held on the powder-propellant attracting surface by a magnetic attraction of the magnetic field. In the invention defined in claim 10, the powder-propellant attracting surface is made of an electrically insulating material, and the powder propellant is made of a ferromagnetic material. In this case, the powder propellant-based space propulsion device further comprises: a magnetic roller designed to have a magnetic field on a surface thereof and disposed between the opening and the powder-propellant attracting surface and in adjacent relation to each of the opening and the powder-propellant attracting surface; and powder-propellant-attracting-surface charging means for electrostatically charging the powder-propellant attracting surface. The magnetic roller is operable to attract the powder propellant in powder-propellant storage container to the surface thereof through the opening and hold the powder propellant by a magnetic force of the magnetic field. Further, the magnetic roller is operable to be rotated so as to transfer the held powder propellant to a position adjacent to the powder-propellant attracting surface. The powder-propellant-attracting-surface charging means is operable to allow the transferred powder propellant to be attracted from the magnetic roller to the powder-propellant attracting surface and held on the powder-propellant attracting surface by an electrostatic attraction.

In the invention defined in claim 11, the powder-propellant-attracting-surface charging means is composed of a charge roller disposed in contact with the powder-propellant attracting surface.

In the invention defined in claim 12, the powder propellant is made of a material which is sublimatable by heating, and at least a part of the powder-propellant attracting surface is formed as a transparent portion made of a transparent material. Further, the propulsive-energy supply means is composed of a laser beam oscillator designed to generate a laser beam and irradiate the powder propellant transferred to the release position, with the laser beam from behind the powder-propellant attracting surface through the transparent portion to heatingly sublimate and release the powder propellant.

In the invention defined in claim 13, the powder propellant is made of a material which is sublimatable by heating, and the propulsive-energy supply means is composed of a pair of main-discharge electrodes disposed inside the jet member and in opposed relation to one another, and a main discharge power supply designed to generate a high voltage and apply the high voltage between the main-discharge electrodes so as to produce a main discharge to heatingly sublimate and release the powder propellant located adjacent to the main-discharge electrodes.

In the invention defined in claim 14, the powder propellant-based space propulsion device further comprises: an igniter including a triggering-discharge electrode designed to produce a triggering discharge for initiating a main discharge between the main-discharge electrodes and disposed inside the jet member and in adjacent relation to the powder-propellant attracting surface; and a triggering-discharge power supply for the triggering discharge. Further, the main-discharge electrodes are composed of a pair of rod-shaped electrodes disposed in opposed relation to one another in a divergent arrangement. The igniter is operable to produce the triggering discharge so as to generate the main discharge between the main-discharge electrodes, and the main-discharge electrodes are operable to sublimate the powder propellant by the main discharge generated therebetween while ionizing at least a part of the sublimated powder propellant, and allow the ionized powder propellant to be expelled toward the downstream side of the jet member based on an electromagnetic interaction between a current supplied to the ionized powder propellant by the main discharge and a magnetic field generated by the main discharge.

In the invention defined in claim 15, the main-discharge electrodes constitute at least a part of the jet member.

In the invention defined in claim 16, the powder propellant is made of a self-heating material which is ignitable by heating, and at least a part of the powder-propellant attracting surface is formed as a transparent portion made of a transparent material. Further, the propulsive-energy supply means is composed of a laser beam oscillator designed to generate a laser beam and irradiate the powder propellant transferred to the release position, with the laser beam from behind the powder-propellant attracting surface through the transparent portion to heatingly ignite and release the powder propellant.

In the invention defined in claim 17, the powder propellant is made of a self-heating material which is ignitable by heating. Further, and the propulsive-energy supply means is composed of a pair of main-discharge electrodes disposed inside the jet member and in opposed relation to one another, and a main discharge power supply designed to generate a high voltage and apply the high voltage between the main-discharge electrodes so as to produce a main discharge to heatingly ignite and release the powder propellant located adjacent to the main-discharge electrodes.

In the invention defined in claim 18, the main-discharge electrodes constitute at least a part of the jet member.

In the invention defined in claim 19, the powder-propellant attracting surface is formed in a cylindrical shape, and the powder-propellant transfer means is designed to rotate the powder-propellant attracting surface about an axis of the cylindrical shape so as to transfer the powder propellant to the release position.

In the invention defined in claim 20, the powder-propellant attracting surface is formed in a partially-cylindrical shape having a sector-shaped bottom, and the powder-propellant transfer means is designed to swing the powder-propellant attracting surface about an axis of the partially-cylindrical shape so as to transfer the powder propellant to the release position.

In the invention defined in claim 21, the powder-propellant attracting surface is formed in a planar shape, and the powder-propellant transfer means is designed to linearly reciprocate the powder-propellant attracting surface so as to transfer the powder propellant to the release position.

In the invention defined in claim 22, the powder-propellant storage container includes powder-propellant agitating means for agitating the powder propellant stored in the powder-propellant storage container. In the invention defined in claim 23, the powder propellant is made of a material which is sublimatable by heating, and the powder-propellant attracting surface is formed in a cylindrical shape or in a partially-cylindrical shape having a sector-shaped bottom. At least a part of the powder-propellant attracting surface is formed as a transparent portion made of a transparent material. Further, the propulsive-energy supply means is composed of a plurality of laser beam oscillators each designed to irradiate a corresponding one of a plurality of different positions of the powder-propellant attracting surface with a laser beam. In this case, plural number of the release positions are defined, respectively, at the plurality of different positions to be irradiated with the laser beam, and each of the laser beam oscillators serving as the propulsive-energy supply means is designed to generate a laser beam, and irradiate the powder propellant transferred to a corresponding one of the release positions, with the laser beam from behind the powder-propellant attracting surface through the transparent portion so as to heatingly sublimate and release the powder propellant.

In the invention defined in claim 24, the powder propellant is made of a self-heating material which is ignitable by heating, and the powder-propellant attracting surface is formed in a cylindrical shape or in a partially-cylindrical shape having a sector-shaped bottom. At least a part of the powder-propellant attracting surface is formed as a transparent portion made of a transparent material. Further, the propulsive-energy supply means is composed of a plurality of laser beam oscillators each designed to irradiate a corresponding one of a plurality of different positions of the powder-propellant attracting surface with a laser beam. In this case, plural number of the release positions are defined, respectively, at the plurality of different positions to be irradiated with the laser beam, and each of the laser beam oscillators serving as the propulsive-energy supply means is designed to generate a laser beam, and irradiate the powder propellant transferred to a corresponding one of the release positions, with the laser beam from behind the powder-propellant attracting surface through the transparent portion to heatingly ignite and release the powder propellant.

In the invention defined in claim 25, the powder propellant is made of a material which is sublimatable by heating, and the powder-propellant attracting surface is formed in a cylindrical shape or in a partially-cylindrical shape having a sector-shaped bottom. At least a part of the powder-propellant attracting surface is formed as a transparent portion made of a transparent material. Further, the propulsive-energy supply means is composed of a laser beam oscillator including laser-beam emitting direction changing means operable to change an emitting direction of a laser beam. In this case, the release position is defined in a given range corresponding to a area of the powder-propellant attracting surface to be irradiated with the laser beam, and the laser beam oscillator serving as the propulsive-energy supply means is designed to generate a laser beam, and irradiate the powder propellant transferred to the release position defined in the range, with the laser beam from behind the powder-propellant attracting surface through the transparent portion so as to heatingly sublimate and release the powder propellant.

In the invention defined in claim 26, the powder propellant is made of a self-heating material which is ignitable by heating, and the powder-propellant attracting surface is formed in a cylindrical shape or in a partially-cylindrical shape having a sector-shaped bottom. At least a part of the powder-propellant attracting surface is formed as a transparent portion made of a transparent material. Further, the propulsive-energy supply means is composed of a laser beam oscillator including laser-beam emitting direction changing means operable to change an emitting direction of a laser beam. In this case, the release position is defined in a given range corresponding to a area of the powder-propellant attracting surface to be irradiated with the laser beam, and the laser beam oscillator serving as the propulsive-energy supply means is designed to generate a laser beam, and irradiate the powder propellant transferred to the release position defined in the range, with the laser beam from behind the powder-propellant attracting surface through the transparent portion so as to heatingly ignite and release the powder propellant.

The powder propellant-based space propulsion device according to the present invention allows a powder propellant having high density and excellent handleability to be supplied on a portion-by-portion basis and released/expelled as a propulsive jet. Thus, the present invention can provide an effect of being able to obtain enhanced performance, particularly higher specific thrust, in a space propulsion device.

### BRIEF DESCRIPTION OF DRAWINGS

FIG. 1 is a schematic perspective view showing the structure of a powder propellant-based space propulsion device 100 according to a first embodiment of the present invention.

FIG. 2 is a schematic perspective view showing the structure of a powder propellant-based space propulsion device 200 according to a second embodiment of the present invention.

FIG. 3 is a schematic perspective view showing the structure of a powder propellant-based space propulsion device 300 according to a third embodiment of the present invention.

FIG. 4 is a schematic perspective view showing the structure of a powder propellant-based space propulsion device 400 according to a fourth embodiment of the present invention.

FIG. 5 is a schematic perspective view showing the structure of a powder propellant-based space propulsion device 500 according to a fifth embodiment of the present invention.

FIG. 6 is a schematic perspective view showing the structure of a powder propellant-based space propulsion device 600 according to a sixth embodiment of the present invention.

FIG. 7 is a schematic perspective view showing the structure of a powder propellant-based space propulsion device 700 according to a seventh embodiment of the present invention.

FIG. 8 is a schematic perspective view showing the structure of a powder propellant-based space propulsion device 800 according to an eighth embodiment of the present invention.

FIG. 9 is a schematic perspective view showing the structure of a powder propellant-based space propulsion device 900 according to a ninth embodiment of the present invention.

### BEST MODE FOR CARRYING OUT THE INVENTION

With reference to the drawings, a powder propellant-based space propulsion device according to an embodiment of the present invention will now be described. In a powder propellant-based space propulsion device of the present invention, a powder propellant stored in a container is attracted to an attracting surface and transferred while being attractively held on the attracting surface. Then, the transferred powder propellant is energized and released to obtain a propulsive jet. The attraction for transferring the powder propellant is implemented by means of; attraction based on an electrostatic force (electrostatic attraction); attraction based on a magnetic force (magnetic attraction); or attraction based on a combination of an electrostatic force and a magnetic force (electrostatic/magnetic combinational attraction). The release of the powder propellant is implemented by means of: electrostatic charge and acceleration based on an electrostatic attraction of an electric field (electrostatic acceleration); heating/sublimation based on a laser beam and acceleration based on resulting increased pressure (laser heating); heating/sublimation based on electric discharge and acceleration based on resulting increased pressure (discharge heating); formation of a plasma based on electric discharge and electromagnetic acceleration (discharge/electromagnetic acceleration); heating/ignition based on a laser beam, formation of high-pressure gas based on heat generation by a chemical reaction and acceleration based on resulting increased pressure (laser ignition); and heating/ignition based on electric discharge; formation of high-pressure gas based on heat generation by a chemical reaction and acceleration based on resulting increased pressure (discharge ignition). The present invention may be implemented by freely combining any one of the above propellant attraction means with any one of the above propellant release means. The present invention will be described in connection with the following representative embodiments thereof: a first embodiment (electrostatic attraction+laser heating); a second embodiment (magnetic attraction+laser heating); a third embodiment (electrostatic/magnetic combinational attraction+laser heating); a fourth embodiment (electrostatic/magnetic combinational attraction+discharge/ electromagnetic acceleration); a fifth embodiment (electrostatic/magnetic combinational attraction+discharge acceleration); a sixth embodiment (electrostatic/magnetic combinational attraction+electrostatic acceleration (with a neutralizer)); and a seventh embodiment (electrostatic/magnetic combinational attraction+electrostatic acceleration (without a neutralizer)).

In the laser heating, a area to be irradiated with a laser beam may be changed to vary a direction of a propulsive jet. As a specific embodiment designed to vary a direction of a propulsive jet in the combination of electrostatic attraction and laser heating, an eighth embodiment (switching between a plurality of laser devices) and a ninth embodiment (variable laser beam emitting direction ) will be described.

### First Embodiment

### Electrostatic Attraction & Laser Heating

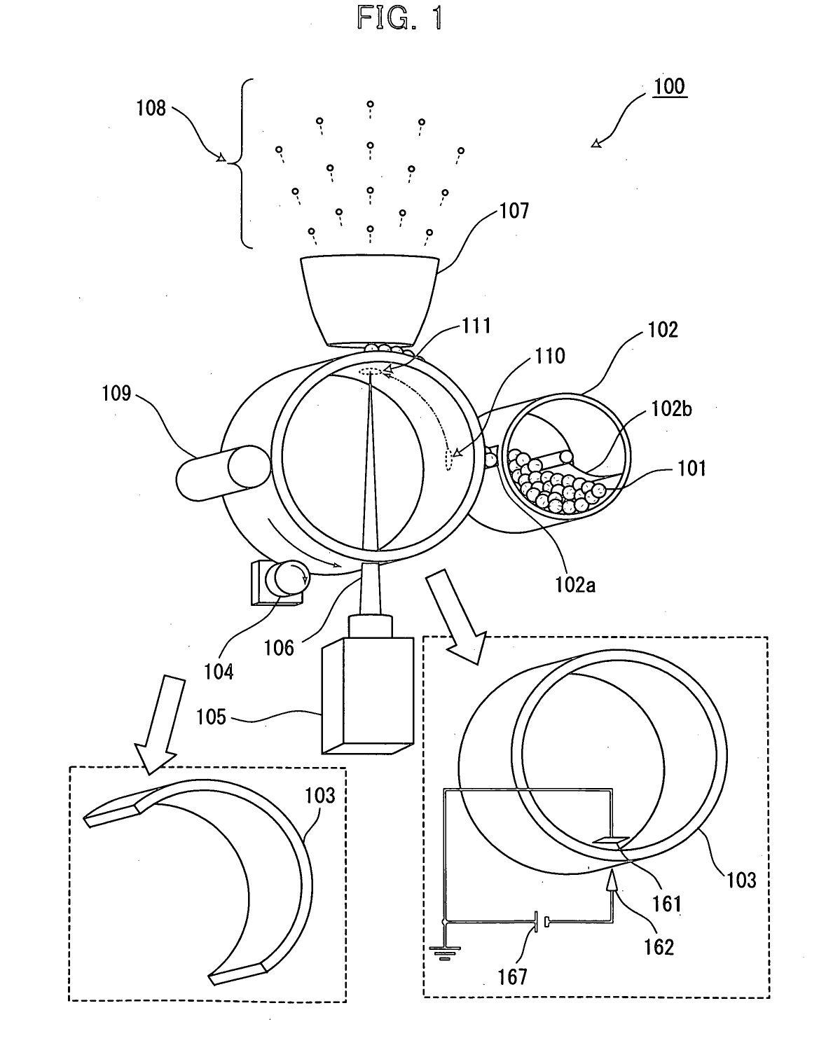

A first embodiment of the present invention will be described below. FIG. 1 is a schematic perspective view showing the structure of a powder propellant-based space propulsion device 100 according to the first embodiment of the present invention. In the powder propellant-based space propulsion device 100, a powder propellant is attracted by means of electrostatic attraction, and released by means of laser heating. The structure of the powder propellant-based space propulsion device 100 will be firstly described. The powder propellant-based space propulsion device 100 comprises a powder-propellant storage container 102, a powder-propellant attracting drum 103, a powder-propellant-attracting-drum rotating motor 104, a laser beam oscillator 105, a nozzle 107 and a charge roller 109. The powder-propellant storage container 102 includes a powder-propellant-storage-container opening 102a for feeding a powder propellant 101 to the outside therethrough, and an agitator 102b for agitating the powder propellant 101 to move the powder propellant 101 to a position charge having an opposite polarity to that of the powder propellant 101 is induced on the powder-propellant attracting drum 103 by electrostatic induction to allow the powder propellant 101 to be attracted to and held on the powder-propellant attracting drum 103 by an electrostatic attraction. In the same manner, when the powder propellant 101 is made of an electrically conductive material, an electric charge having an opposite polarity to that of the powder propellant 101 is induced on the powder-propellant attracting drum 103 by electrostatic induction to allow the powder propellant 101 to be attracted to and held on the powder-propellant attracting drum 103 by an electrostatic attraction. In this case, the powder-propellant storage container 102 is preferably made of an electrically insulating material to prevent the electric charge on the powder-propellant attracting drum 103 from escaping through the conductive powder propellant 101.

The material of the powder propellant 101 is not limited to PTFE (Teflon®) which has heretofore been used as a material of propellants, but may be selected from a wide range of materials. Specifically, the powder propellant 101 may be made of any suitable material capable of being gasified and electrostatically charged without difficulty, such as polypropylene, polyethylene or vinyl chloride.

Alternatively, the powder propellant 101 may be a self-heating material which is ignitable by heating to generate heat through a chemical reaction, such as an oxidation reaction. In this case, the powder propellant 101 is heated and ignited by a laser beam 106 (laser ignition). An explosive containing an oxidant may be used as this powder propellant 101 (one example of modification using a self-heating powder propellant). Specifically, a solid propellant, such as boron/potassium nitrate (NAB), hydroxyl-terminated polybutadiene/ammonium perchlorate (HTPB/AP) or glycidyle azide polymer (GAP), may be used.

The powder-propellant storage container 102 is provided as one specific example of storage means having an inner space for storing a propellant or the powder propellant 101. The powder-propellant storage container 102 has the powder-propellant-storage-container opening 102a serving as an opening for feeding the powder propellant 101 to the outside adjacent to the powder-propellant-storage-container opening 102a. The powder propellant-based space propulsion device 100 includes a housing (not shown) containing the above components while adequately maintaining a positional relationship therebetween. The powder propellant-based space propulsion device 100 further includes a controller (not shown) 112 for controlling respective operations of the agitator 102b, the powder-propellant-attracting-drum rotating motor 104 and the laser beam oscillator 105 in association with each other. In the powder propellant-based space propulsion device 100, the powder propellant 101 is used as a propellant.

The powder propellant 101 is made of a material which is sublimatable by heating based on energization thereof. When the sublimated material is released/expelled from the powder propellant-based space propulsion device 100, it can produce a thrust for the space propulsion device 100. The powder propellant 101 consists of fine particles or a solid in powder form, and has the features of solid, such as high density, high storage efficiency, excellent handleability/storageability on the ground and no need for a working liquid and a high-pressure system in transfer, as well as the features of liquid or gas, such as easiness of transfer on a portion-by-portion basis in a required volume. The powder propellant-based space propulsion device 100 is operated in a substantially vacuum-pressure environment, and therefore the powder propellant 101 may be made of a material which is sublimatable by heating in a substantially vacuum-pressure environment. When the powder propellant 101 is applied with energy or energized, it will be sublimated and transformed into high-temperature/high-pressure gas. The high-temperature/high-pressure gas is accelerated by its own pressure, and released/expelled as a propulsive jet 108. A thrust is produced by a reaction force against the propulsive jet 108. This thrust producing process is referred to as “laser ablation”.

The powder propellant 101 is attracted to and held on the powder-propellant attracting drum 103 by an electrostatic attraction. The powder propellant 101 may be made of an electrically insulating material, or may be made of an electrically conductive material. When the powder propellant 101 is made of an electrically insulating material, an electric therethrough, and includes the agitator 102b for agitating the powder propellant 101 to move the powder propellant 101 to a position adjacent to the powder-propellant-storage-container opening 102a. The agitation of the powder propellant 101 using the agitator 102b makes it possible to prevent aggregation of the powder propellant 101 so as to ensure stable feeding. The agitator 102b is controlled in such a manner as to be rotationally and/or reciprocatingly moved within an adequate positional range, at an adequate rotational speed and in an adequate rotational direction. This control allows the powder propellant 101 to be adequately agitated and fed in a required volume. The powder-propellant storage container 102 may include a flexible doctor blade (not shown) 102c disposed on the outer side of the powder-propellant-storage-container opening 102a. In this case, the doctor blade 102c may be disposed in such a manner that an edge thereof is pressed to the powder propellant 301 attractively held on and transferred by the powder-propellant attracting drum 103 to scrape excess powder propellant 301 from the powder-propellant attracting drum 103 and smooth the powder propellant 301. During this process, the edge of the doctor blade 102c may be pressed onto the powder propellant 101 to friction the powder propellant 101 so as to allow the powder propellant 101 to be electrostatically charged in an opposite polarity to that of the powder-propellant attracting drum 103.

The powder-propellant attracting drum 103 is provided as one specific example of a powder-propellant attracting surface for attracting the powder propellant 101 in the powder-propellant storage container 102 thereto through the powder-propellant-storage-container opening 102a and attractively holding the attracted powder propellant 101 thereon. The powder-propellant attracting drum 103 is operable to attract and hold the powder propellant 101 thereto and thereon in an attraction position 110. The attraction position 110 is a positional zone determined by a positional relationship between the powder-propellant attracting drum 103 and other component, such as the powder-propellant storage container 102. While the attraction position 110 has a circular shape in FIG. 1, it may be an elongated shape. Preferably, the powder-propellant attracting drum 103 has a cylindrical shape. Preferably, the powder-propellant attracting drum 103 is formed as a cylindrical-shaped drum made of a material transparent to an after-mentioned laser beam 106. The powder-propellant attracting drum 103 has a surface electrostatically charged so as to attract the powder propellant 101 from the powder-propellant-storage-container opening 102a to the surface and attractively hold the attracted powder propellant 101 on the surface by an electrostatic attraction acting between the surface and powder propellant 101.

Instead of a perfect cylindrical shape, the surface of the powder-propellant attracting drum 103 for attracting and holding the powder propellant 101 may have a partially-cylindrical shape (partially-circular cylinder-like shape or armor-like shape) having a sector-shaped bottom. The area surrounded by the dashed box on the left side of FIG. 1 shows one example of the powder-propellant attracting drum 103 having a partially-cylindrical shape. The shape of the powder-propellant attracting drum 103 is not limited to a cylindrical shape, but may be formed in any suitable shape other than a drum shape, such as a different curved shape or a planar shape (one example of modification using a powder-propellant attracting drum having a shape other than a cylindrical shape).

The powder-propellant-attracting-drum rotating motor 104 is provided as one specific example of powder-propellant transfer means for rotationally move the powder-propellant attracting drum 103 serving as a powder-propellant attracting surface and having a area for attractively holding the powder propellant 101 thereon, according to control of the controller 112, to transfer the powder propellant 101 to a release position for releasing the powder propellant. The powder-propellant-attracting-drum rotating motor 104 may be integrated with the powder-propellant attracting drum 103. The powder-propellant-attracting-drum rotating motor 104 is controlled in such a manner as to be rotated in a required number of rotations, at an adequate rotational speed and in an adequate rotational direction. The powder-propellant-attracting-drum rotating motor 104 is operable to switch between two opposite rotational directions of the powder-propellant attracting drum 103 when it has a partially-cylindrical shape, or to reciprocate the powder-propellant attracting drum 103 when it has a planar shape (one example of modification using a powder-propellant attracting drum having a shape other than a cylindrical shape).

The powder-propellant-attracting-drum rotating motor 104 is also operable to move the powder-propellant attracting drum 103 serving as a powder-propellant attracting surface in such a manner that the area for attractively holding the powder propellant 101 (hereinafter referred to as “powder-propellant holding area”) in the powder-propellant attracting drum 103 is returned to the attraction position 110 adjacent to the opening 102c of the powder-propellant storage container 102 in a repetitive manner. Thus, the powder-propellant attracting surface which attractively held the powder propellant once can be repeatedly used as a powder-propellant attracting surface. This makes it possible to minimize an area of the powder-propellant attracting surface and reduce in size and weight of the powder propellant-based space propulsion device 100.

The powder-propellant-attracting-drum rotating motor 104 may be designed to rotate the powder-propellant attracting drum 103 in one direction, or may be designed to rotate the powder-propellant attracting drum 103 alternately in opposite directions. Specifically, when the powder-propellant attracting drum 103 having a surface for attracting and attractively holding the powder propellant 101 is formed in a partially-cylindrical shape having a sector-shaped bottom, the powder-propellant-attracting-drum rotating motor 104 may be designed to swingably rotate the powder-propellant attracting drum 103 about an axis of the partially-cylindrical shape alternately in opposite directions. Further, when the powder-propellant attracting drum 103 having a surface for attracting and attractively holding the powder propellant 101 is formed in a planar shape, the powder-propellant-attracting-drum rotating motor 104 may be designed to linearly reciprocate the powder-propellant attracting drum 103 (one example of modification using a powder-propellant attracting drum having a shape other than a cylindrical shape).

The laser beam oscillator 105 is provided as one specific example of propulsive-energy supply means for energizing the powder propellant 101 transferred to the release position 111 to accelerate and release the powder propellant 101 as a propulsive jet. The laser beam oscillator 105 is disposed at a position capable of emitting a laser beam 106 onto a rear surface of the powder-propellant holding area of the powder-propellant attracting drum 103 at the release position 111. Preferably, the laser beam oscillator 105 is disposed on the opposite side of the release position 111 with respect to the powder-propellant attracting drum 103 in such a manner that an optical axis of the laser beam 106 to be oscillated by and emitted from the laser beam oscillator 105 is aimed at the release position 111. This arrangement where the laser beam oscillator 105 is disposed on the opposite side of the release position 111 can prevent the laser beam oscillator 105 from being contaminated by the sublimated powder propellant 101. The laser beam oscillator 105 is operable to oscillate the laser beam 106, and irradiate/heat the powder propellant 101 transferred to the release position with the laser beam 106. The laser beam oscillator 105 may include a lens disposed on a downstream side of a position for emitting the laser beam 106 to focus the oscillated laser beam so as to concentrate energy at a specific position at the release position. The release position 111 has no component blocking the expelling of the powder propellant 101. The release position 111 is a positional zone determined by a positional relationship between the powder-propellant attracting drum 103 and other component, such as the powder-propellant storage container 102. While the release position 111 has a circular shape in FIG. 1, it may be a trip shape.

The nozzle 107 is provided as one specific example of a jet member for guiding the powder propellant 101 sublimated into high-pressure gas to the outside as the propulsive jet 108. Preferably, the nozzle 107 is formed as a divergent tube-shaped nozzle. The nozzle 107 has two openings consisting of a narrow opening formed at an upstream end thereof (upstream open end), and a wide opening formed at a downstream end thereof (downstream open end). The upstream open end of the nozzle 107 is disposed adjacent to the release position 111 in a surrounding manner. As used in this specification, the term “opening direction” of the nozzle 107 means a direction extending from the center of the upstream open end to the center of the downstream open end. The powder propellant 101 is released and expelled in the opening direction as the propulsion jet 108. The nozzle 107 is disposed in such a manner that the opening direction is aligned with a direction allowing the powder propellant 101 sublimated into high-pressure gas to be accelerated while receiving the largest described below. The powder propellant 101 is stored in the powder-propellant storage container 102. In order to prevent aggregation of the powder propellant 101, the agitator 102b may be activated according to need to rotationally move and agitate the powder propellant 101. In response to receiving a command to expel the propulsive jet 108, from a satellite attitude control computer or the like, the controller 112 instructs the agitator 102b to appropriately move the powder propellant 101 to a position adjacent to the powder-propellant-storage-container opening 102a of the powder-propellant storage container 102. Under control of the controller 112, the agitator 102b moves a required volume of the powder propellant 101 to allow the powder propellant 101 to be adequately fed.

The powder-propellant attracting drum 103 is rotated according to a rotation of the powder-propellant-attracting-drum rotating motor 104 controlled by the controller 112, and applied with a high voltage from the charge roller 109 in contact therewith, so as to allow the front surface of the powder-propellant attracting drum 103 to be electrostatically charged in advance. In the alternative modification where the powder-propellant-attracting-surface charging means consists of the first charge electrode 161, the second charge electrode 162 and the charge-electrode power supply 167, the front surface of the powder-propellant attracting drum 103 is electrostatically charged in advance by the first and second charge electrodes 161, 162 disposed, respectively, on the sides of the front and rear surfaces of the powder-propellant attracting drum 103 (one example of modification using a pair of charge electrodes).

In the attraction position 110, the powder-propellant attracting drum 103 rotated according to the rotation of the powder-propellant-attracting-drum rotating motor 104 attracts the powder propellant 101 fed by the agitator 102b under control of the controller 112, through the powder-propellant-storage-container opening 102a by an electrostatic attraction of the electric charge carried on the front surface of the powder-propellant attracting drum 103. The controller 112 adequately controls each of the movement of the agitator 102b in the powder-propellant storage container 102 and the rotation of the powder-propellant-attracting-drum rotating motor 104 in such a manner as to allow the powder propellant 101 to be attracted to the powder-propellant attracting drum 103 on a transferred to the release position 11, to activate the laser beam oscillator 105 so as to oscillate and emit the laser beam 106 to appropriately irradiate the powder propellant 101 with the laser beam 106. The controller 112 is designed to receive an output of a sensor or the like so as to detect a position of the powder propellant 101 on the powder-propellant attracting drum 103, and instruct the laser beam oscillator 105 based on the detected position to emit the laser beam to the powder propellant 101.

As an alternative modification of the powder-propellant-attracting-surface charging means, a pair of charge electrodes may be used as substitute for the charge roller 109. The structurally-modified portion in the alternative modification is shown in the area surrounded by the dashed box on the right side of FIG. 1. Specifically, in this alternative modification, a first charge electrode 161, a second charge electrode 162 and a charge-electrode power supply 167 are used in place of the charge roller 109. In the alternative modification illustrated in the dashed box of FIG. 1, a front surface (outer surface of the cylinder) of the powder-propellant attracting drum 103 is negatively charged. The charge-electrode power supply 167 applies a positive potential and a negative potential, respectively, to the first charge electrode 161 and the second charge electrode 162. According to an electric field produced by a potential difference between the first and second electrodes 161, 162, an electron is emitted from a tip of the second charge electrode 162. In the course of being drawn toward the first charge electrode 161, the emitted electron is captured by the front surface of the powder-propellant attracting drum 103, and thereby the front surface of the powder-propellant attracting drum 103 is negatively charged. Simultaneously, by electrostatic induction, a positive charge is induced on a rear surface (inner surface of the cylinder) on the opposite side of the negatively-charged front surface of the powder-propellant attracting drum 103. When the respective polarities of charges to be carried on the front and rear surfaces of the powder-propellant attracting drum 103 are reversed, the respective positions of the first and second charge electrodes 161, 162 may be counterchanged (one example of modification using a pair of charge electrodes).

An operation of the powder propellant-based space propulsion device 100 will be force. This direction corresponds to a direction perpendicular to the surface of the powder-propellant attracting drum 103 at the release position 111 where the powder propellant 101 is sublimated into high-pressure gas. The nozzle 107 serves as a shield for preventing the sublimated powder propellant 101 from spreading over surroundings and attaching on surrounding devices/structures as a re-solidified substance causing contamination thereof, and as means for adequately controlling a direction and speed of the propulsive jet 108 to efficiently obtain a thrust.

The charge roller 109 is provided as one specific example of powder-propellant-attracting- surface charging means for electrostatically charging the powder-propellant attracting drum 103. The charge roller 109 is disposed in line contact with the powder-propellant attracting drum 103, and applied with a high voltage having a polarity corresponding to that of an electric charge to be carried on the powder-propellant attracting drum 103. The charge roller 109 is designed to be evenly brought into contact with the entire front surface of the powder-propellant attracting drum 103 while being rotated about a center shaft thereof in conjunction with the rotation of the powder-propellant attracting drum 103 so as to electrostatically charge the powder-propellant attracting drum 103. In this manner, the front surface of the powder-propellant attracting drum 103 can be electrostatically charged reliably and uniformly. For example, the powder-propellant attracting drum 103 may be composed of an electrically-conductive roller applied with a high voltage. Instead of the charge roller 109, the powder-propellant-attracting-surface charging means may comprise a pair of electrodes disposed, respectively, on the sides of front and rear surfaces of the powder-propellant attracting drum 103.

The controller 112 consists of a control circuit which is operable, in response to a command to expel the propulsive jet 108, to activate the agitator 102b so as to agitate the powder propellant 101 at an appropriate position and feed the powder propellant 101 to the powder-propellant attracting drum 103 and then appropriately activate the powder-propellant-attracting-drum rotating motor 104 so as to transfer the powder propellant 101 attractively held on the powder-propellant attracting drum 103, and, when the powder propellant 101 is portion-by-portion basis in a required volume.

The powder-propellant-attracting-drum rotating motor 104 rotates the powder-propellant attracting drum 103 according to the rotation thereof to transfer the area for attractively holding the powder propellant 101 (or the powder-propellant holding area) of the powder-propellant attracting drum 103 from the attraction position 110 to the release position 111 for releasing the powder propellant 101. Preferably, the powder propellant 101 is sequentially or serially attracted and transferred. The controller 112 adequately controls the rotational speed of the powder-propellant attracting drum 103.

The controller 112 detects that the powder propellant 101 has been transferred to the release position 111, based on an output of a sensor or the number of rotations of the powder-propellant- attracting-drum rotating motor 104, and instructs the laser beam oscillator 105 to oscillate and emit the laser beam 106 so as to allow the powder-propellant holding area of the powder-propellant attracting drum 103 transferred to the release position 111 to be irradiated with the laser beam 106 from behind or the rear surface thereof. In the case where the powder propellant 101 is serially transferred, the laser beam 106 is serially emitted in synchronization therewith. The powder propellant 101 irradiated with the laser beam 106 absorbs energy of the laser beam. Thus, the powder propellant 101 is heated and sublimated into a high-temperature/high-pressure gas. The resulting high-pressure gas exerts a pressure perpendicular to the front surface of the powder-propellant attracting drum 103 at the release position 111, and receives the same level of perpendicular pressure from the front surface as a counteraction against the exerted pressure. Thus, the high-pressure gas is accelerated in the direction perpendicular to the front surface. Then, the accelerated high-pressure gas is guided by the nozzle 107 and expelled toward a downstream side in the opening direction of the nozzle 107 as the propulsive jet 108 so as to produce a thrust as a counteraction against the propulsive jet 108.

In this manner, the laser beam 106 can be emitted for a given time period to adequately control and manage a volume of the powder propellant 101 to be produced as the propulsive jet 108, so as to prevent a delay in sublimation of the powder propellant 101. This makes it powder-propellant-attracting-drum rotating motor 104 so as to control a volume of the powder propellant 101 to be supplied.

### Second Embodiment

### Magnetic Attraction & Laser Heating

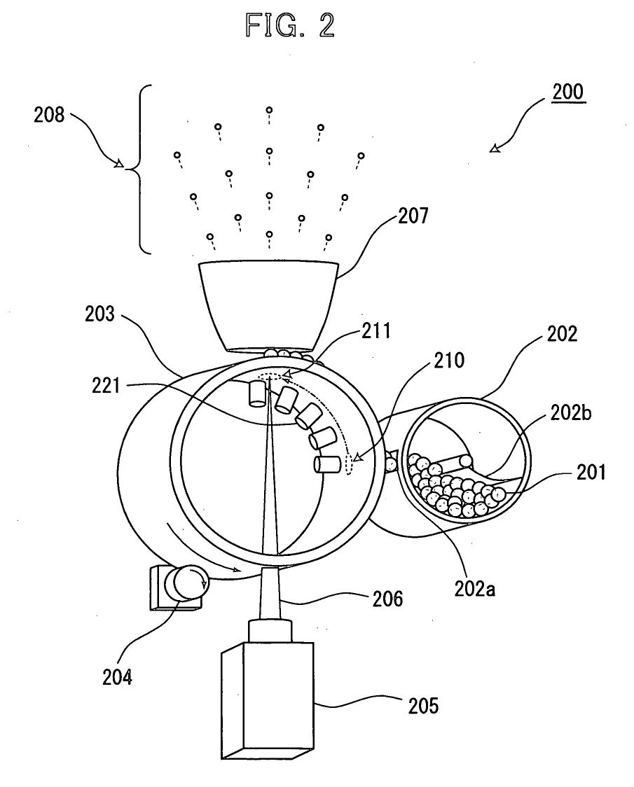

A second embodiment of the present invention will be described below. FIG. 2 is a schematic perspective view showing the structure of a powder propellant-based space propulsion device 200 according to the second embodiment of the present invention. In the powder propellant-based space propulsion device 200, a powder propellant is attracted by means of magnetic attraction, and released by means of laser heating as with the first embodiment. The structure of the powder propellant-based space propulsion device 200 will be firstly described. In FIG. 2, a component equivalent to that in other embodiments is defined by a reference numeral having the common tens and ones digits. The powder propellant-based space propulsion device 200 comprises a powder-propellant storage container 202, a powder-propellant attracting drum 203, a powder-propellant-attracting-drum rotating motor 204, a laser beam oscillator 205, a nozzle 207, 112 and a powder-propellant attracting magnet 221. The powder-propellant storage container 102 includes a powder-propellant-storage-container opening 202a and an agitator 202b. The powder propellant-based space propulsion device 200 includes a housing (not shown) containing the above components while adequately maintaining a positional relationship therebetween. The powder propellant-based space propulsion device 200 further includes a controller (not shown) 212 for controlling respective operations of the agitator 202b, the powder-propellant-attracting-drum rotating motor 204 and the laser beam oscillator 205 in association with each other. The powder propellant-based space propulsion device 200 is different from the powder propellant-based space propulsion device 100 according to the first embodiment, in that the powder propellant-based space propulsion device 200 includes the powder-propellant attracting magnet 221 as an additional component without using the charge roller 109. In the powder propellant-based space propulsion device 200, a powder propellant 201 is used as a propellant.

While the powder propellant 201 is made of a material which is sublimatable by heating, possible to prevent deterioration in performance of the powder propellant-based space propulsion device 100, and to employ a wide range of materials for the powder propellant 101 without being limited to PTFE (Teflon®) so as to achieve further enhanced performance.

In the case where the powder propellant 101 is made of a self-heating material, the powder propellant 101 is ignited by heating using the laser beam 106 to produce explosive combustion, and transformed into high-temperature/high-pressure gas by heat generated during a chemical reaction in the combustion. The gas is guided by the nozzle 107 and expelled toward the opening direction as the propulsive jet 108 so as to produce a thrust as a counteraction against the propulsive jet 108 (one example of modification using a self-heating powder propellant).

The controller 112 instructs the powder-propellant-attracting-drum rotating motor 104 to adequately rotate the powder-propellant attracting drum 103 in such a manner that the powder-propellant holding area of the powder-propellant attracting drum 103 after being irradiated with the laser beam 106 is moved and returned to the attraction position 110 adjacent to the powder-propellant-storage-container opening 102a of the powder-propellant storage container 102 in a repetitive manner. For example, the powder-propellant attracting drum 103 is rotated in one direction so as to allow the powder-propellant holding area of the powder-propellant attracting drum 103 after being irradiated with the laser beam 106 to be returned to the attraction position 110 with respect to each 360-degree rotation in a repetitive manner. In the case where the powder-propellant attracting drum 103 has a partially-cylindrical shape, the rotational direction of the powder-propellant attracting drum 103 may be changed in the reverse direction so as to allow the powder-propellant holding area of the powder-propellant attracting drum 103 after being irradiated with the laser beam 106 to be returned to the attraction position 110 with respect to each reciprocating movement in a repetitive manner (one example of modification using a powder-propellant attracting drum having a shape other than a cylindrical shape). When the powder-propellant attracting drum 103 is continuously rotated in one direction, the powder propellant 101 can be serially supplied and released/expelled. The controller 112 can control the rotational speed of the command to expel a propulsive jet 208, from a satellite attitude control computer or the like, the controller 212 instructs the agitator 202b to appropriately move the powder propellant 201 to a position adjacent to the powder-propellant-storage-container opening 202a of the powder-propellant storage container 202. In the attraction position 210, the powder-propellant attracting drum 203 attracts the powder propellant 201 fed through the powder-propellant-storage-container opening 202a of the powder-propellant storage container 202 by a magnetic force of the powder-propellant attracting magnet 221 disposed along a rear surface of the powder-propellant attracting drum 203. Under control of the controller 212, the powder-propellant-attracting-drum rotating motor 204 rotates the powder-propellant attracting drum 203 according to a rotation thereof to transfer a area for attractively holding the powder propellant 201 (or a powder-propellant holding area) of the powder-propellant attracting drum 203 from the attraction position 210 to the release position 211 for releasing the powder propellant 201. During the course of transferring the powder propellant 201 along the transfer path, the powder propellant 201 is attractively held on the powder-propellant attracting drum 203 by the magnetic force of the powder-propellant attracting magnet 221 disposed along the rear surface of the powder-propellant attracting drum 203. Subsequently, in the same manner as that in the powder propellant-based space propulsion device 100 according to the first embodiment, the controller 212 performs controls for releasing/expelling the powder propellant 201 and returning the powder-propellant holding area of the powder-propellant attracting drum 203 to the attraction position 210 in a repetitive manner.

### Third Embodiment

### Electrostatic/Magnetic Combinational Attraction & Laser Heating

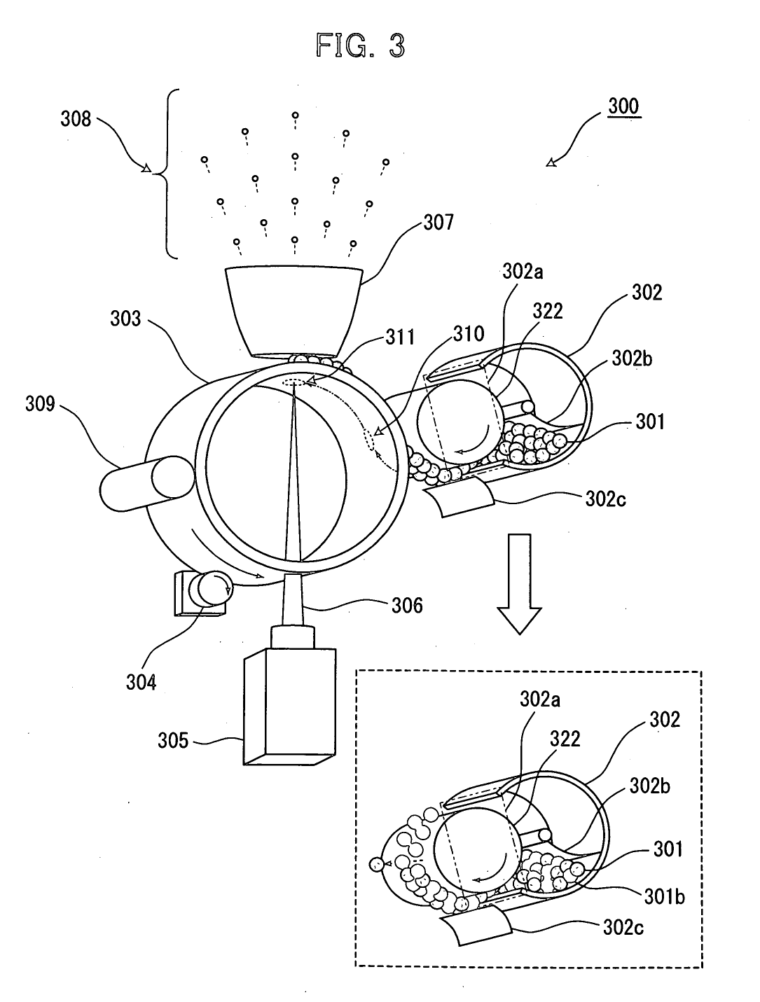

A third embodiment of the present invention will be described below. FIG. 3 is a schematic perspective view showing the structure of a powder propellant-based space propulsion device 300 according to the third embodiment of the present invention. In the powder propellant-based space propulsion device 300, a powder propellant is attracted by means of electrostatic/magnetic combinational attraction, and released by means of laser as with the powder propellant 101 in the first embodiment, it is different from the powder propellant 101 in that the material of the powder propellant 201 has ferromagnetic properties. The powder propellant 201 is attracted to the powder-propellant attracting drum 203 and transferred while being attractively held on the powder-propellant attracting drum 203, by a magnetic force of the powder-propellant attracting magnet 221. The powder propellant 201 may be made of a material consisting of the same material as that of the powder propellant 101 and a ferromagnetic material contained therein. Alternatively, the powder propellant 201 may be a self-heating material having ferromagnetic properties (one example of modification using a self-heating powder propellant).

Each of the powder-propellant storage container 202, the powder-propellant attracting drum 203, the powder-propellant-attracting-drum rotating motor 204, the laser beam oscillator 205, the nozzle 207 and the controller 212 has the same structure as the corresponding component in the first embodiment, except that that the powder-propellant attracting drum 203 in the second embodiment is required to be made of a material which does not shield a magnetic field. The powder-propellant attracting magnet 221 may be any type of magnet capable of generating a magnetic force, for example, a permanent magnet.

The powder-propellant attracting magnet 221 is provides as one specific attracting magnet. The powder-propellant attracting magnet 221 is composed, for example, of permanent magnets which are disposed inside a hollow powder-propellant attracting drum 203 in such as manner as to allow the powder propellant 201 on the powder-propellant attracting drum 203 to be applied with a sufficient magnetic field along a transfer path from an attraction position 210 to a release position 211.

An operation of the powder propellant-based space propulsion device 200 will be described below. While the operation of the powder propellant-based space propulsion device 200 is partly the same as that of the powder propellant-based space propulsion device 100 according to the first embodiment, the mechanism and operation for attracting and transferring the powder propellant 201 are different from those in the powder propellant-based space propulsion device 100, as follows. In response to receiving a heating as with the first embodiment. The structure of the powder propellant-based space propulsion device 300 will be firstly described. In FIG. 3, a component equivalent to that in other embodiments is defined by a reference numeral having the common tens and ones digits. The powder propellant-based space propulsion device 300 comprises a powder-propellant storage container 302, a powder-propellant attracting drum 303, a powder-propellant-attracting-drum rotating motor 304, a laser beam oscillator 305, a nozzle 307, a charge roller 309 and a magnet roll 322. The powder-propellant storage container 302 includes a powder-propellant-storage-container opening 302a, an agitator 302b and a doctor blade 302c. The powder propellant-based space propulsion device 300 includes a housing (not shown) containing the above components while adequately maintaining a positional relationship therebetween. The powder propellant-based space propulsion device 300 further includes a controller (not shown) 312 for controlling respective operations of the agitator 302b, the powder-propellant-attracting-drum rotating motor 304 and the laser beam oscillator 305 in association with each other. The powder propellant-based space propulsion device 300 is different from the powder propellant-based space propulsion device 100 according to the first embodiment, in that the powder propellant-based space propulsion device 300 includes the magnet roll 322 and the doctor blade 302c as additional components. In the powder propellant-based space propulsion device 300, a powder propellant 301 is used as a propellant. In an alternative modification of the third embodiment, the powder propellant 301 is made of a non-magnetic material, and a ferromagnetic powder-propellant carrier 301b is mixed with the powder propellant 301 to transfer the powder propellant 301. The structurally-modified portion in the alternative modification where powder-propellant carrier 301b is used in combination with the powder propellant 301 is shown in the area surrounded by the dashed box in FIG. 3 (one example of modification using a powder-propellant carrier).

While the powder propellant 301 is made of a material which is sublimatable by heating, as with the powder propellant 101 in the first embodiment, it is different from the powder propellant 101 in that the material of the powder propellant 301 has ferromagnetic properties. The powder propellant 301 is fed while being attractively held on the magnet roll 322 by a magnetic force of the magnet roll 322, and then transferred while being attractively held on the powder-propellant attracting drum 303 by an electrostatic attraction. The powder propellant 301 may be made of a material consisting of the same material as that of the powder propellant 101 and a ferromagnetic material contained therein. Alternatively, the powder propellant 301 may be a self-heating material having ferromagnetic properties (one example of modification using a self-heating powder propellant).

Each of the powder-propellant storage container 302, the powder-propellant attracting drum 303, the powder-propellant-attracting-drum rotating motor 304, the laser beam oscillator 305, the nozzle 307, the charge roller 309 and the controller 312 has the same structure as the corresponding component in the first embodiment, except that the powder-propellant-storage-container opening 302a in the third embodiment is formed to have a larger size capable of receiving a part of the magnet roll 322 therein.

The doctor blade 302c is a flexible blade disposed on the outer side of the powder-propellant-storage-container opening 302a of the powder-propellant storage container 302. The doctor blade 302c is disposed in such a manner that an edge thereof is pressed to the powder propellant 301 attractively held on the magnet roll 322 and fed to the outside. The pressed edge of the doctor blade 302c is operable to scrape excess powder propellant 301 from a surface of the magnet roll 322 and smooth the powder propellant 301. During this process, the edge of the doctor blade 302c is pressed onto the powder propellant 301 to friction the powder propellant 301 so as to allow the powder propellant 301 to be electrostatically charged.

The magnet roll 322 is provided as one specific example of a magnetic roller, and formed as a cylindrical-shaped roller having a magnetic field on a surface thereof. The magnet roll 322 is disposed in the vicinity of an attraction position for attracting the powder propellant 301 and in adjacent relation to the powder-propellant attracting drum 303. Instead of a line contact, the magnet roll 322 and the powder-propellant attracting drum 303 are disposed in opposed relation to one another with a small gap therebetween. Preferably, the magnet roll 322 is designed to be rotated about a center shaft thereof in synchronization with the rotation of the powder-propellant attracting drum 303. Preferably, the magnet roll 322 includes a magnet, such as a permanent magnet, embedded therein to provide a magnet field which appears on the surface thereof. Preferably, most of the magnet roll 322 is housed in the powder-propellant storage container 302 in such a manner as to be in contact with the powder propellant 301, and a part of the magnet roll 322 is exposed to the outside through the powder-propellant-storage- container opening 302a.

In the aforementioned alternative modification of the third embodiment, the transfer of the powder propellant 301 is performed based on a two-component system additionally using the powder-propellant carrier 301b. In the two-component system, the powder propellant 301 is made of a non-magnetic material, and the powder-propellant carrier 301b is made of a ferromagnetic material. The area surrounded by the dashed box in FIG. 3 is an explanatory schematic diagram showing the two-component system. In FIG. 3, the powder-propellant carrier 301b indicated by the blacken-out circle is mixed with the powder propellant 301 and stored in the powder-propellant storage container 302 (one example of modification using a powder-propellant carrier). In the two-component system, the powder propellant 301 may be made of a material which is sublimatable by heating, or may be made of a self-heating material (one example of modification using a self-heating powder propellant).

An operation of the powder propellant-based space propulsion device 300 will be described below. While the operation of the powder propellant-based space propulsion device 300 is partly the same as that of the powder propellant-based space propulsion device 100 according to the first embodiment, the mechanism and operation for attracting and transferring the powder propellant 301 are different from those in the powder propellant-based space propulsion device 100, as follows. In response to receiving a command to expel a propulsive jet 308, from a satellite attitude control computer or the like, the controller 312 instructs the agitator 302b to appropriately move the powder propellant 301 to a position adjacent to a portion of the magnet roll 322 residing in the powder-propellant storage container 302. The magnet roll 322 attracts the ferromagnetic powder propellant 301 and attractively holds the ferromagnetic powder propellant 301 on the surface thereof by a magnetic force of the magnetic field on the surface. The magnetic roll 322 is rotated to move the held powder propellant 301 toward the powder-propellant-storage-container opening 302a while attractively holding the powder propellant 301 on another portion of the surface thereof in a sequential manner, so as to feed the powder propellant 301 to the powder-propellant attracting drum 303. The powder propellant 301 getting out of the powder-propellant-storage-container opening 302a while being attractively held on the magnet roll 322 is frictioned by the doctor blade 302c and electrostatically charged before being attracted by the powder-propellant attracting drum 303.

As with the powder-propellant attracting drum 103 in the first embodiment, a front surface of the powder-propellant attracting drum 303 is electrostatically charged in advance. When the powder propellant 301 electrostatically charged after getting out of the powder-propellant- storage-container opening 302a is fed to the attraction position 310 while being attractively held on the magnet roll 322, the powder-propellant attracting drum 303 attracts the powder propellant 301 from the surface of the magnet roll 322, and attractively holds the powder propellant 301 on the front surface thereof. Under control of the controller 312, the powder-propellant-attracting-drum rotating motor 304 rotates the powder-propellant attracting drum 303 according to a rotation thereof to transfer a area for attractively holding the powder propellant 301 (or a powder-propellant holding area) of the powder-propellant attracting drum 303 from the attraction position 310 to a release position 311 for releasing the powder propellant 301. Subsequently, in the same manner as that in the powder propellant-based space propulsion device 100 according to the first embodiment, the controller 312 performs controls for releasing/expelling the powder propellant 301 and returning the powder-propellant holding area of the powder-propellant attracting drum 303 to the attraction position 310 in a repetitive manner.

An operation of the aforementioned alternative modification where the powder-propellant carrier 301b is mixed with the powder propellant 301 and stored in the powder-propellant storage container 302 will be described below. In this alternative modification, the ferromagnetic powder-propellant carrier 301b is mixed with the non-magnetic powder propellant 301 and stored in the powder-propellant storage container 302. In response to receiving a command to expel a propulsive jet 308, from a satellite attitude control computer or the like, the controller 312 instructs the agitator 302b to appropriately move a mixture of the powder propellant 301 and the powder-propellant carrier 301b to a position adjacent to a portion of the magnet roll 322 located inside the powder-propellant-storage-container opening 302a of the powder-propellant storage container 302. The magnet roll 322 attracts the ferromagnetic powder-propellant carrier 301b together with the powder propellant 301 mixed therewith, and attractively holds them on the surface thereof by a magnetic force of the magnetic field on the surface. The powder propellant 301 will be attractively held as with the powder-propellant carrier 301b by a frictional force relative to particles of the powder-propellant carrier 301b residing therearound and others. The magnetic roll 322 is rotated to move the held the mixture of the powder propellant 301 and the powder-propellant carrier 301b toward the powder-propellant-storage-container opening 302a while attractively holding the mixture of the powder propellant 301 and the powder-propellant carrier 301b on another portion of the surface thereof in a sequential manner, so as to feed the mixture of the powder propellant 301 and the powder-propellant carrier 301b to the powder-propellant attracting drum 303. As with the third embodiment, the powder propellant 301 getting out of the powder-propellant-storage-container opening 302a while being attractively held on the magnet roll 322 is frictioned by the doctor blade 302c and electrostatically charged together with the powder-propellant carrier 301b before being attracted by the powder-propellant attracting drum 303 (one example of modification using a powder-propellant carrier).

As with the powder-propellant attracting drum 103 in the first embodiment, a front surface of the powder-propellant attracting drum 303 is electrostatically charged in advance. In the attraction position 310, the powder-propellant attracting drum 303 attracts only the powder propellant 301 in the mixture of the powder propellant 301 and the powder-propellant carrier 301b, from the surface of the magnet roll 322, and attractively holds the powder propellant 301 on the front surface thereof. Thus, only the powder-propellant carrier 301b is left in the portion of the magnet roll 322 after only the powder propellant 301 is attracted to the powder-propellant attracting drum 303. Although not illustrated, it is preferable that the powder-propellant carrier 301b left on the magnet roll 322 is scraped off by a blade or the like in contact with the magnet roll 322 at a subsequent position to the position where only the powder propellant 301 is attracted. Subsequently, in the same manner as that in the powder propellant-based space propulsion device 100 according to the first embodiment, the controller 312 performs controls for releasing/expelling the powder propellant 301 and returning the powder-propellant holding area of the powder-propellant attracting drum 303 to the attraction position 310 in a repetitive manner.

### Fourth Embodiment

### Electrostatic/Magnetic Combinational Attraction & Discharge/Electromagnetic Acceleration

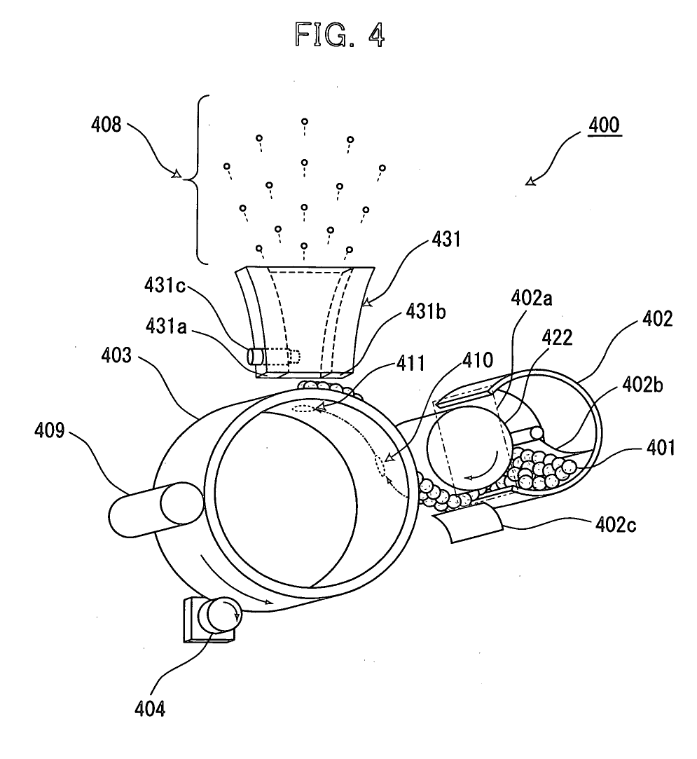

A fourth embodiment of the present invention will be described below. FIG. 4 is a schematic perspective view showing the structure of a powder propellant-based space propulsion device 400 according to the fourth embodiment of the present invention. In the powder propellant-based space propulsion device 400, a powder propellant is attracted by means of electrostatic/magnetic combinational attraction as with the third embodiment, and released by means of discharge/electromagnetic acceleration.

The structure of the powder propellant-based space propulsion device 400 will be firstly described. In FIG. 4, a component equivalent to that in other embodiments is defined by a reference numeral having the common tens and ones digits. The powder propellant-based space propulsion device 400 comprises a powder-propellant storage container 402, a powder-propellant attracting drum 403, a powder-propellant-attracting-drum rotating motor 404, a charge roller 409, a magnet roll 422 and a nozzle 431. The powder-propellant storage container 402 includes a powder-propellant-storage-container opening 402a, an agitator 402b and a doctor blade 402c. The nozzle 431 includes a main-discharge electrode 431a, a main-discharge electrode 431b and an igniter 431c. The powder propellant-based space propulsion device 400 includes a housing (not shown) containing the above components while adequately maintaining a positional relationship therebetween. The powder propellant-based space propulsion device 400 further includes a controller (not shown) 412 for controlling respective operations of the agitator 402b, the powder-propellant-attracting-drum rotating motor 404 and the igniter 431c in association with each other. The powder propellant-based space propulsion device 400 is different from the powder propellant-based space propulsion device 300 according to the third embodiment, in that the powder propellant-based space propulsion device 400 includes the nozzle 431 as an additional component without using components equivalent to the laser beam oscillator 305 and the nozzle 307 in the third embodiment. In the powder propellant-based space propulsion device 400, a powder propellant 401 is used as a propellant.

The powder propellant 401 is made of a material which is sublimatable and ionizable to produce a plasma, by electric discharge. In this embodiment, in order to transfer the powder propellant 401 by means of electrostatic/magnetic combinational attraction, the powder propellant 401 is made of a ferromagnetic material. Alternatively, as in the alternative modification of the third embodiment, a two-component system may be used in which the powder propellant 401 is made of a non-magnetic material, and a ferromagnetic powder-propellant carrier 401b (not shown) is mixed with the powder propellant 401 to transfer the powder propellant 401 (one example of modification using a powder-propellant carrier).

Each of the powder-propellant storage container 402, the powder-propellant attracting drum 403, the powder-propellant-attracting-drum rotating motor 404, the charge roller 409, the controller 412 and the magnet roll 422 has the same structure as the corresponding component in the third embodiment, except that the controller 412 is electrically connected to a triggering-discharge power supply of the igniter 431c.

The nozzle 431 is provided as one specific example of a combination of propulsive-energy supply means for supplying energy to the powder propellant 401, and a jet member for guiding a sublimated powder propellant 401 to the outside as a propulsive jet 408. Specifically, the nozzle 431 serving as the jet member is operable to adequately control a direction and speed of the propulsive jet 408 so as to efficiently obtain a thrust, while preventing the powder propellant 401 sublimated into high-pressure gas from spreading over surroundings and attaching on surrounding devices/structures as a re-solidified substance causing contamination thereof. Preferably, the main-discharge electrode 431a and the main-discharge electrode 431b included in the nozzle 431 are composed of a pair of rod-shaped electrodes disposed in opposed relation to one another in a divergent arrangement where a distance therebetween gradually increases in a downstream direction of the propulsive jet 408. Preferably, the nozzle 431 has two side walls formed in the same configuration and disposed to sandwich the opposed main-discharge electrodes 431a, 431b therebetween so as to define a divergent inner space in the nozzle 431. The nozzle 431 formed in a divergent rectangular parallelepiped shape makes it possible to define a linear space between the main-discharge electrodes 431a, 431b so as to allow the main-discharge electrodes 431a, 431b to stably generate a main discharge therebetween, and to expel the propulsive jet 408 in the downstream direction through the divergent inner space at a maximized speed and in a concentrated manner. The main-discharge electrodes 431a, 431b are provided as means for sublimating and ionized the powder propellant 401 to produce a plasma, based on a high-voltage electric power supplied therebetween from a main-discharge power supply (not shown), so as to electromagnetically accelerate the plasma.

The igniter 431c is provided as an igniter plug including a triggering-discharge electrode adapted to generate a triggering discharge for initiating a main discharge, based on an electric power supplied thereto from a triggering-discharge power supply (not shown). The igniter 431c has a body penetratingly embedded in either one of the main-discharge electrodes 431a, 431b (main-discharge electrodes 431c in this embodiment) in such a manner as to allow the triggering-discharge electrode to be exposed to the inner space of the nozzle 431. The igniter 431c has one or two triggering-discharge electrodes. When the igniter 431c has one triggering-discharge electrode, a triggering discharge is generated between this triggering-discharge electrode and the main-discharge electrodes 431c. When the igniter 431c has two triggering-discharge electrodes, a triggering discharge is generated between these triggering-discharge electrodes. The controller 412 is operable to control the timing at which the triggering-discharge power supply allows the igniter 431c to generate a triggering discharge.

An operation of the powder propellant-based space propulsion device 400 will be described below. While the operation of the powder propellant-based space propulsion device 400 is partly the same as that of the powder propellant-based space propulsion device 300 according to the third embodiment, the mechanism and operation for releasing/expelling the powder propellant 401 are different from those in the powder propellant-based space propulsion device 300, as follows.

As with the powder-propellant attracting drum 103 in the first embodiment, a front surface of the powder-propellant attracting drum 403 is electrostatically charged in advance. When the powder propellant 401 electrostatically charged after getting out of the powder-propellant storage container 402 is fed to an attraction position 410 while being attractively held on the magnet roll 422, the powder-propellant attracting drum 403 attracts the powder propellant 401 from a surface of the magnet roll 422, and attractively holds the powder propellant 401 on the front surface thereof, by an electrostatic attraction acting between the powder-propellant attracting drum 403 and the powder propellant 401. The powder propellant 401 attractively held on the powder-propellant attracting drum 403 is transferred to a release position 411 by the action of the powder-propellant-attracting-drum rotating motor 404 controlled by the controller 412. The main-discharge power supply (not shown) applies a high voltage between the main-discharge electrode 431a and the main-discharge electrode 431b. A main discharge is to be instantaneously generated between the main-discharge electrodes 431a, 431b. Thus, the main-discharge power supply is preferably composed of a device capable of instantaneously supplying a large current, for example, a charged capacitor. At the timing of initiating a main discharge between the main-discharge electrodes 431a, 431b, a small triggering discharge is generated using the triggering-discharge electrode of the igniter 431c under control of the controller 412. Through the triggering discharge, a plasma consisting of ions and electrons is produced around the triggering-discharge electrode. The plasma is accelerated by an electric field between the main-discharge electrodes 431a, 431b, and collided molecules are further ionized to induce a main discharge.

The powder propellant 401 in the vicinity of the release position 411 is sublimated by heat generated through the main discharge, and the sublimated powder propellant 401 is ionized to produce a plasma, through a collision with ions and electrons from a current of the main discharge and heat generated by the current of the main discharge, and the produced plasma further facilitates flow of the current of the main discharge. In this manner, a pulsed main discharge is generated.

The main discharge current flowing between the main-discharge electrodes 431a, 431b generates a self-induced magnetic field around the main discharge current in an annular pattern. The main discharge current flows across the plasma, and the plasma is electromagnetically accelerated in the downstream direction by an interaction between the plasma current and the self-induced magnetic field. The accelerated plasma is guided by the nozzle 431 and expelled toward the downstream side in an opening direction of the nozzle 431 as the propulsive jet 408 to produce a thrust as a counteraction against the propulsive jet 408. This plasma acceleration mechanism is the same as an acceleration mechanism of a pulsed plasma thruster (PPT). Subsequently, in the same manner as that in the powder propellant-based space propulsion device 100 according to the first embodiment, the controller 412 performs a control for returning a area for attractively holding the powder propellant 401 (powder-propellant holding area) in the powder-propellant attracting drum 403 to the attraction position 410 in a repetitive manner.

### Fifth Embodiment

### Electrostatic/Magnetic Combinational Attraction & Discharge Heating

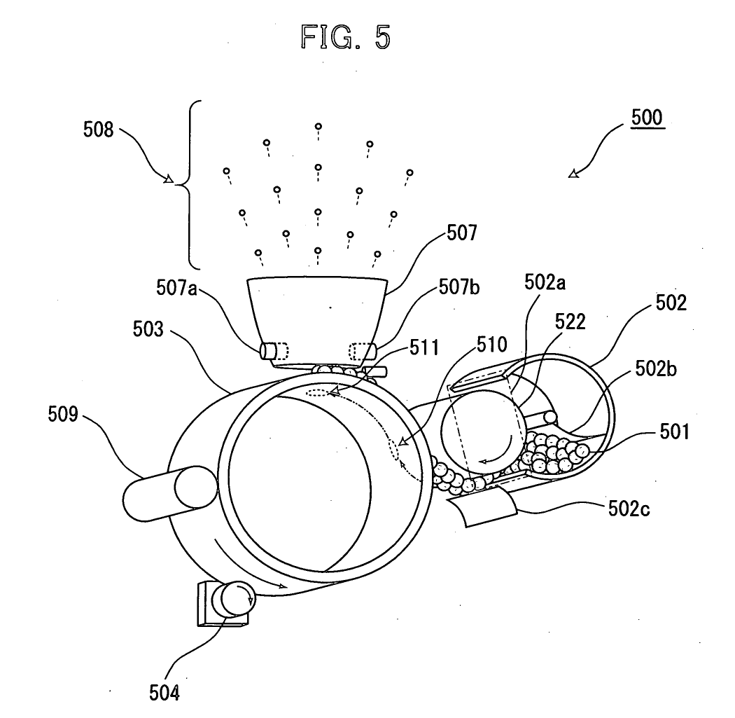

A fifth embodiment of the present invention will be described below. FIG. 5 is a schematic perspective view showing the structure of a powder propellant-based space propulsion device 500 according to the fifth embodiment of the present invention. In the powder propellant-based space propulsion device 500, a powder propellant is attracted by means of electrostatic/magnetic combinational attraction as with the third embodiment, and released by means of discharge heating.

The structure of the powder propellant-based space propulsion device 500 will be firstly described. In FIG. 5, a component equivalent to that in other embodiments is defined by a reference numeral having the common tens and ones digits. The powder propellant-based space propulsion device 500 comprises a powder-propellant storage container 502, a powder-propellant attracting drum 503, a powder-propellant-attracting-drum rotating motor 504, a nozzle 507, a charge roller 509 and a magnet roll 522. The powder-propellant storage container 502 includes a powder-propellant-storage-container opening 502a, an agitator 502b and a doctor blade 502c. The nozzle 507 includes a main-discharge electrode 507a and a main-discharge electrode 507b. The powder propellant-based space propulsion device 500 includes a housing (not shown) containing the above components while adequately maintaining a positional relationship therebetween. The powder propellant-based space propulsion device 500 further includes a controller (not shown) 512 for controlling respective operations of the agitator 502b, the powder-propellant-attracting-drum rotating motor 504 and the main-discharge electrodes 507a, 507b in association with each other. The powder propellant-based space propulsion device 500 is different from the powder propellant-based space propulsion device 400 according to the fourth embodiment, in that the powder propellant-based space propulsion device 500 includes the nozzle 507 without using a component equivalent to the nozzle 431 in the fourth embodiment.

A powder propellant 501 is made of a material which is sublimatable by heating, and has ferromagnetic properties, as with the powder propellant 301. Alternatively, the powder propellant 501 may be made of a ferromagnetic self-heating material. Further, as in the alternative modification of the third embodiment, a two-component system may be used in which the powder propellant 501 is made of a non-magnetic material, and a ferromagnetic powder-propellant carrier 501b (not shown) is mixed with the powder propellant 501 to transfer the powder propellant 501 (one example of modification using a powder-propellant carrier). In this two-component system, the powder propellant 501 may be made of a material which is sublimatable by heating, or may be made of a self-heating material (one example of modification using a self-heating powder propellant).

Each of the powder-propellant storage container 502, the powder-propellant attracting drum 503, the powder-propellant-attracting-drum rotating motor 504, the charge roller 509, the controller 512 and the magnet roll 522 has the same structure as the corresponding component in the fourth embodiment, except that the controller 512 is electrically connected to a main-discharge power supply of the main-discharge electrode 507a and the main-discharge electrode 507b.

The nozzle 507 is provided as one specific example of a combination of propulsive-energy supply means for supplying energy to the powder propellant 501, and a jet member for guiding a sublimated powder propellant 501 to the outside as a propulsive jet 508. Specifically, the nozzle 507 serving as the jet member is operable to adequately control a direction and speed of the propulsive jet 508 so as to efficiently obtain a thrust, while preventing the powder propellant 501 sublimated into high-pressure gas from spreading over surroundings and attaching on surrounding devices/structures as a re-solidified substance causing contamination thereof. Preferably, the main-discharge electrode 507a and the main-discharge electrode 507b included in the nozzle 507 are disposed in such a manner that a gap therebetween is located immediately above a release position 511 on the powder-propellant attracting drum 503. This arrangement allows the powder propellant 501 on the powder-propellant attracting drum 503 to be efficiently heated by energy of a main discharge generated between the main-discharge electrodes 507a, 507b. The main-discharge electrodes 507a, 507b are provided as means for sublimating the powder propellant 501 based on a high-voltage electric power supplied therebetween from a main-discharge power supply (not shown).

An operation of the powder propellant-based space propulsion device 500 will be described below. While the operation of the powder propellant-based space propulsion device 500 is partly the same as that of the powder propellant-based space propulsion device 400 according to the fourth embodiment, the mechanism and operation for releasing/expelling the powder propellant 501 are different from those in the powder propellant-based space propulsion device 400, as follows.

As with the powder-propellant attracting drum 103 in the first embodiment, a front surface of the powder-propellant attracting drum 503 is electrostatically charged in advance. When the powder propellant 501 electrostatically charged after getting out of the powder-propellant storage container 502 is fed to an attraction position 510 while being attractively held on the magnet roll 522, the powder-propellant attracting drum 503 attracts the powder propellant 501 from a surface of the magnet roll 522, and attractively holds the powder propellant 501 on the front surface thereof, by an electrostatic attraction acting between the powder-propellant attracting drum 503 and the powder propellant 501. The powder propellant 501 attractively held on the powder-propellant attracting drum 503 is transferred to the release position 511 by the action of the powder-propellant-attracting-drum rotating motor 504 controlled by the controller 512. At the timing of initiating a main discharge between the main-discharge electrodes 507a, 507b, the main-discharge power supply applies an extra-high voltage therebetween according to control of the controller 512. This main discharge is instantaneously generated. Thus, the main-discharge power supply is preferably composed of a device capable of instantaneously supplying a large current, for example, a charged capacitor and an extra-high voltage induction coil connected to the capacitor. In response to an extra-high voltage supplied from the main-discharge power supply, an instantaneous discharge is generated between the main-discharge electrodes 507a, 507b to heat the powder propellant 501. Preferably, the powder propellant 501 is disposed at a position where it is interposed in a discharge path, so as to allow a discharge current to flow directly through the powder propellant 501 and heat the powder propellant 501. The heated powder propellant 501 is sublimated into a high-temperature/high-pressure gas. The high-pressure gas is guided by the nozzle 507 and expelled toward the downstream side in an opening direction of the nozzle 507 as the propulsive jet 508 to produce a thrust as a counteraction against the propulsive jet 508. Subsequently, in the same manner as that in the powder propellant-based space propulsion device 100 according to the first embodiment, the controller 512 performs a control for returning a area for attractively holding the powder propellant 501 (powder-propellant holding area) in the powder-propellant attracting drum 503 to the attraction position 510 in a repetitive manner.

A component equivalent to the igniter 431c in the fourth embodiment may be disposed between the main-discharge electrodes 507a, 507b. In this case, a certain level of high voltage is applied between the main-discharge electrodes 507a, 507b in advance. Then, the igniter 431c generates a small triggering discharge using a triggering-discharge electrode thereof. This triggering discharge induces a main discharge between the main-discharge electrodes 507a, 507b to transform the powder propellant 501 into a high-pressure gas (one example of modification using an igniter).

### Sixth Embodiment

### Electrostatic/Magnetic Combinational Attraction & Electrostatic Acceleration (with Neutralizer)

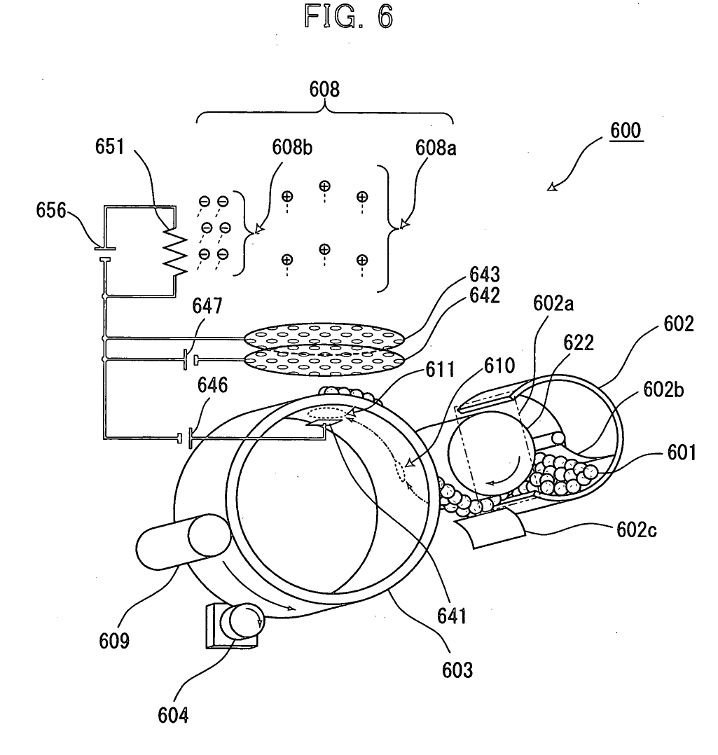

A sixth embodiment of the present invention will be described below. FIG. 6 is a schematic perspective view showing the structure of a powder propellant-based space propulsion device 600 according to the sixth embodiment of the present invention. In the powder propellant-based space propulsion device 600, a powder propellant is attracted by means of electrostatic/magnetic combinational attraction as with the third embodiment, and released by means of electrostatic acceleration. Further, a neutralizer is used therein. The structure of the powder propellant-based space propulsion device 600 will be firstly described. In FIG. 6, a component equivalent to that in other embodiments is defined by a reference numeral having the common tens and ones digits. The powder propellant-based space propulsion device 600 comprises a powder-propellant storage container 602, a powder-propellant attracting drum 603, a powder-propellant-attracting-drum rotating motor 604, a charge roller 609, a magnet roll 622, a first electrode 641, a second electrode 642, a third electrode 643, a first electrode power supply 646, a second electrode power supply 647, a neutralizer 651 and a neutralizer power supply 656. The powder-propellant storage container 602 includes a powder-propellant-storage-container opening 602a, an agitator 602b and a doctor blade 602c. The powder propellant-based space propulsion device 600 includes a housing (not shown) containing the above components while adequately maintaining a positional relationship therebetween. The powder propellant-based space propulsion device 600 further includes a controller (not shown) 612 for controlling respective operations of the agitator 602b, the powder-propellant-attracting-drum rotating motor 604, the first electrode power supply 646, the second electrode power supply 647 and the neutralizer power supply 656 in association with each other. The powder propellant-based space propulsion device 600 is different from the powder propellant-based space propulsion device 500 according to the fifth embodiment, in that the powder propellant-based space propulsion device 500 includes the first electrode 641, the second electrode 642, the third electrode 643, the first electrode power supply 646, the second electrode power supply 647, the neutralizer 651 and the neutralizer power supply 656, without using a component equivalent to the nozzle 507 in the fifth embodiment.

Preferably, a powder propellant 601 is formed of electrically-insulating fine particles 2 which are easy to be electrostatically charged and attractively held. It is not essential for the powder propellant 601 to have a chemically special property, such as a self-heating property. The powder propellant 601 is made of a material easy to be positively charged. In the case where the powder propellant 601 is fed to the powder-propellant attracting drum 603 by means of electrostatic/magnetic combinational attraction as shown in FIG. 6, the powder propellant 601 is made of a ferromagnetic material. Further, as in the alternative modification of the third embodiment, a two-component system may be used in which the powder propellant 601 is made of a non-magnetic material, and a ferromagnetic powder-propellant carrier 601b (not shown) is mixed with the powder propellant 601 to transfer the powder propellant 601 (one example of modification using a powder-propellant carrier).

Each of the powder-propellant storage container 602, the powder-propellant attracting drum 603, the powder-propellant-attracting-drum rotating motor 604, the charge roller 609, the controller 612 and the magnet roll 622 has the same structure as the corresponding component in the fourth embodiment, except that the controller 612 is electrically connected to the first electrode power supply 646, the second electrode power supply 647 and the neutralizer power supply 656.

In this embodiment, the powder propellant 601 is accelerated using an acceleration technique based on the same principle as that of a technique for used in a conventional ion rocket to accelerate a positive ion in a plasma. In order to provide an explanation about a role of an accelerating electrode for the powder propellant 601 in the powder propellant-based space propulsion device 600 by comparison with an accelerating electrode in the conventional ion rocket, the accelerating electrode in the conventional ion rocket will be firstly described below. The conventional ion rocket employs two accelerating electrodes consisting of a screen grid (screen electrode) and an acceleration grid (acceleration electrode), preferably, three accelerating electrodes having a deceleration grid (deceleration electrode) in addition to the two accelerating electrodes. The screen grid is set at a given potential, preferably a positive potential, for adapting gaseous plasma thereto. The acceleration grid is set at a potential relatively to the screen grid, which allows a positive ion to be accelerated, i.e. at a negative potential relative to the screen grid, which allows potential energy of a positive ion to be lowered, so as to accelerate the positive ion based on a potential difference therebetween. A space between the screen grid and the acceleration grid serves as an acceleration zone, or a zone having an electric field to be applied to a positive ion so as to accelerate the positive ion in an expelling direction thereof. The deceleration grid is set at a potential relative to the acceleration grid, which allows the positive ion to be slightly decelerated, i.e. at a positive potential relative to the acceleration grid, so as to slightly decelerate the positive ion based on a potential difference therebetween. Further, with respect to oppositely-charged particles residing on a downstream side of the deceleration grid, the deceleration grid is designed to provide a potential difference allowing the oppositely-charged particles to be accelerated in the downstream direction, so as to prevent the oppositely-charged particles from getting into the acceleration zone.

An accelerating electrode of the powder propellant-based space propulsion device 600 will be described below. The first electrode 641 is equivalent to the screen grid of the conventional ion rocket. The first electrode 641 is disposed in opposed relation to a rear surface of the powder-propellant attracting drum 603 at a position corresponding to a front surface area thereof where the powder propellant 601 is attractively held in a release position 611. The first electrode 641 is designed to have a given potential, preferably, a potential with the same polarity as that of the electrostatically-charged powder propellant 601. Specifically, the powder propellant 601 is positively charged, and therefore the first electrode 641 is set at a positive potential. The first electrode 641 set at such a potential makes it possible to give higher potential energy to the electrostatically-charged powder propellant 601 so as to facilitate acceleration thereof. The first electrode 641 disposed on the side of the rear surface of the powder-propellant attracting drum 603 is not required to allow the powder propellant 601 to pass therethrough. Thus, it is not necessary to form the first electrode 641 into a grid structure.

The second electrode 642 is equivalent to the acceleration grid of the conventional ion rocket. The second electrode 642 is disposed in opposed relation to the front surface area of the powder-propellant attracting drum 603 where the powder propellant 601 is attractively held at the release position 611. The second electrode 642 is designed to have a potential relatively to the first electrode 641, which allows the powder propellant 601 to be accelerated, i.e. a potential relative to the first electrode 641, which has an opposite polarity to that of the electrostatically-charged powder propellant 601 and allows potential energy of the electrostatically-charged powder propellant 601 to be lowered, so as to accelerate the electrostatically-charged powder propellant 601 based on a potential difference therebetween. Specifically, the powder propellant 601 is positively charged, and therefore the second electrode 642 is set at a negative potential. The second electrode 642 is required to allow the powder propellant 601 to pass therethrough. Thus, the second electrode 642 is preferable formed into a grid structure. An accelerating electric field capable of accelerating the powder propellant 601 in an expelling direction thereof is formed between the first and second electrodes 641 and 642. Thus, the acceleration zone corresponds to a space between the powder-propellant holding area of the powder-propellant attracting drum 603 at the release position 611 and the second electrode 642.

The third electrode 643 is equivalent to the deceleration grid of the conventional ion rocket. The third electrode 643 is disposed on the downstream side of the second electrode 642 in adjacent and opposed relation to the second electrode 642. The second electrode 642 is designed to have a potential relatively to the second electrode 642, which allows the powder propellant 601 to be slightly decelerated, i.e. a potential relative to the second electrode 642, which has the same polarity as that of the electrostatically-charged powder propellant 601 and allows potential energy of the electrostatically-charged powder propellant 601 to be increased, so as to slightly decelerate the electrostatically-charged powder propellant 601 based on a potential difference therebetween. Specifically, the powder propellant 601 is positively charged, and therefore the third electrode 643 is set at a positive potential. The third electrode 643 is required to allow the powder propellant 601 to pass therethrough. Thus, the third electrode 643 is preferable formed into a grid structure, and disposed in such a manner as to align each grid hole with a corresponding grid hole of the second electrode 642. While the third electrode 643 can facilitate efficient acceleration of the powder propellant 601, it is not essential. After expelling the electrostatically-charged powder propellant 601, the charge has to be neutralized. As a particle for use in the neutralization, an electron is more desirable than a positive ion. Thus, the powder propellant 601 is made of a material to be positively charged.

The first electrode power supply 646 is designed to allow the first electrode 641 to have an adequate potential difference relative to other electrode. The second electrode power supply 647 is designed to allow the second electrode 642 to have an adequate potential difference relative to other electrode. The electrode to be provided with a power supply is not limited to the first and second electrodes 641, 642. That is, a potential difference is a relative value, and therefore at least any two of the three electrodes may be provided, respectively, with power supplies.

The neutralizer 651 is designed to emit an electron for neutralizing an electric charge of the electrostatically-charged powder propellant 601 to be expelled, and disposed on the downstream side of the third electrode 643 at a laterally displaced position relative to an axis of the third electrode 643. The neutralizer 651 includes a hot cathode adapted to emit a thermoelectron for neutralizing a positively-charged particle. The neutralizer power supply 656 is designed to supply to the neutralizer 651 an electric power for heating the hot cathode included in the neutralizer 651.

An operation of the powder propellant-based space propulsion device 600 will be described below. While the operation of the powder propellant-based space propulsion device 600 is partly the same as that of the powder propellant-based space propulsion device 500 according to the fifth embodiment, the mechanism and operation for releasing/expelling the powder propellant 601 are different from those in the powder propellant-based space propulsion device 500, as follows.

As with the powder-propellant attracting drum 103 in the first embodiment, the front surface of the powder-propellant attracting drum 603 is electrostatically charged in advance. When the powder propellant 601 electrostatically charged after getting out of the powder-propellant storage container 602 is fed to an attraction position 610 while being attractively held on the magnet roll 622, the powder-propellant attracting drum 603 attracts the powder propellant 601 from a surface of the magnet roll 622, and attractively holds the powder propellant 601 on the front surface thereof, by an electrostatic attraction acting between the powder-propellant attracting drum 603 and the powder propellant 601. The powder propellant 601 attractively held on the powder-propellant attracting drum 603 is transferred to the release position 611 by the action of the powder-propellant-attracting-drum rotating motor 604 controlled by the controller 612. The powder propellant 601 is positively charged. The controller 612 instructs each of the first electrode power supply 646, the second electrode power supply 647 and the neutralizer power supply 656 to generate a desired voltage. The first electrode 641 disposed on the side of the rear surface of the powder-propellant attracting drum 603 is set at a positive potential, and the second electrode 642 disposed on the side of the front surface of the powder-propellant attracting drum 603 is set at a negative potential. The positively-charged powder propellant 601 transferred to the release position 611 is accelerated in the downstream direction or toward the second electrode 642, by an electric field based on a potential difference between the first and second electrode 641, 642. After passing through the grid holes of the second electrode 642, the powder propellant 601 is further expelled in the downstream direction. When the powder propellant 601 passing through the grid holes of the second electrode 642 is further expelled in the downstream direction through the grid holes of the third electrode 643, it is slightly decelerated by an electric field generated between the second and third electrodes 642, 643 in a direction causing a deceleration of the powder propellant 601. The electrostatically-charged powder propellant 601 is expelled downstream of the third electrode 643 as an electrostatically-charged powder propellant jet 608a or a jet flow of the electrostatically-charged powder propellant 601 to produce a thrust as a counteraction against the powder propellant jet 608a.

An electron 608b is emitted from the hot cathode of the neutralizer 651 which is heated by an electric power from the neutralizer power supply 656. The emitted electron 608b drifts around the downstream side of the third electrode 643. Due to the potential difference between the second and third electrodes 642, 643, this electron 608b receives a force in the downstream direction, and hardly gets into the inward side of the second electrode 642 or the acceleration zone, through the holes of the third electrode 643. The electron 608b is attracted to the positive charge of the electrostatically-charged powder propellant jet 608a, and bonded with the positively-charged powder propellant 601 to neutralize the positive charge thereof. In this manner, the electrostatically-charged powder propellant jet 608a is neutralized, and expelled downstream of the third electrode in the form of an electrically-neutral propulsive jet 608. Subsequently, in the same manner as that in the powder propellant-based space propulsion device 100 according to the first embodiment, the controller 612 performs a control for returning a area for attractively holding the powder propellant 601 (powder-propellant holding area) in the powder-propellant attracting drum 603 to the attraction position 610 in a repetitive manner.

### Seventh Embodiment

### Electrostatic/Magnetic Combinational Attraction & Electrostatic Acceleration (without Neutralizer)

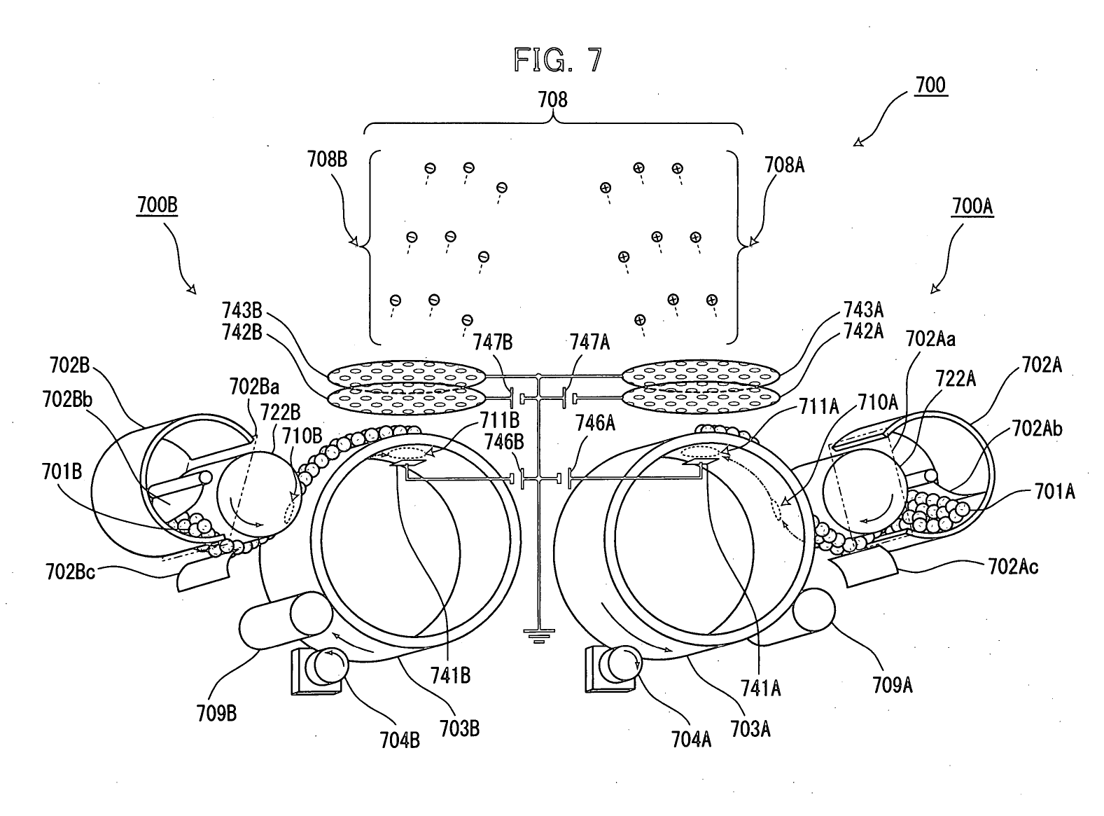

A seventh embodiment of the present invention will be described below. FIG. 7 is a schematic perspective view showing the structure of a powder propellant-based space propulsion device 700 according to the seventh embodiment of the present invention. In the powder propellant-based space propulsion device 700, a powder propellant is attracted by means of electrostatic/magnetic combinational attraction as with the third embodiment, and released by means of electrostatic acceleration. No neutralizer is used therein.

The structure of the powder propellant-based space propulsion device 700 will be firstly described. In FIG. 7, a component equivalent to that in other embodiments is defined by a reference numeral having the common tens and ones digits. The powder propellant-based space propulsion device 700 generally comprises a first propulsion sub-device 700A and a second propulsion sub-device 700B which are disposed adjacent to one another in such a manner that they are oriented in a common downstream direction. Except that each of the first propulsion sub-device 700A and the second propulsion sub-device 700B includes an electrode for expelling a powder propellant electrostatically charged to an opposite polarity, they have approximately the same structure. In FIG. 7, an equivalent component between the first and second propulsion sub-devices 700A, 700B is defined by the same reference numeral in a state after removing a capital alphabetical character suffixed thereto.

The first propulsion sub-device 700A comprises a powder-propellant storage container 702A, a powder-propellant attracting drum 703A, a powder-propellant-attracting-drum rotating motor 704A, a charge roller 709A, a magnet roll 722A, a first electrode 741A, a second electrode 742A, a third electrode 743A, a first electrode power supply 746A and a second electrode power supply 747A. The powder-propellant storage container 702A includes a powder-propellant-storage-container opening 702Aa, an agitator 702Ab and a doctor blade 702Ac.

The second propulsion sub-device 700B comprises a powder-propellant storage container 702B, a powder-propellant attracting drum 703B, a powder-propellant-attracting-drum rotating motor 704B, a charge roller 709B, a magnet roll 722B, a first electrode 741B, a second electrode 742B, a third electrode 743B, a first electrode power supply 746B and a second electrode power supply 747B. The powder-propellant storage container 702B includes a powder-propellant- storage-container opening 702Ba, an agitator 702Bb and a doctor blade 702Bc. The powder propellant-based space propulsion device 700 includes a housing (not shown) containing the above components while adequately maintaining a positional relationship therebetween. The powder propellant-based space propulsion device 700 further includes a controller (not shown) 712 for controlling respective operations of the agitators 702Ab, 702Bb, the powder-propellant-attracting-drum rotating motors 704A, 704B, the first electrode power supplies 746A, 746B, and the second electrode power supplies 747A, 747B in association with each other. The powder propellant-based space propulsion device 700 is different from the powder propellant-based space propulsion device 600 according to the sixth embodiment, in that the powder propellant-based space propulsion device 700 comprises the first and second propulsion sub-devices 700A, 700B each of which incorporates the components of the powder propellant-based space propulsion device 600 except for the neutralizer 651 and the neutralizer power supply 656.

Preferably, each of a powder propellant 701A and a powder propellant 701B is formed of electrically-insulating fine particles 2 which are easy to be electrostatically charged and attractively held. The powder propellant 701A is made of a material easy to be positively charged, and the powder propellant 701B is made of a material easy to be negatively charged. In the case where each of the powder propellants 701A, 701B is fed to a corresponding one of the powder-propellant attracting drums 703A, 703B by means of electrostatic/magnetic combinational attraction as shown in FIG. 7, each of the powder propellants 701A, 701B is made of a ferromagnetic material. Further, as in the alternative modification of the third embodiment, a two-component system may be used in which each of the powder propellants 701A, 701B is made of a non-magnetic material, and each of ferromagnetic powder-propellant carriers 701Ab, 701Bb (not shown) is mixed with the powder propellants 701A, 701B respectively, to transfer the powder propellant (one example of modification using a powder-propellant carrier).

Each of the powder-propellant storage containers 702A, 702B, the powder-propellant attracting drums 703A, 703B, the powder-propellant-attracting-drum rotating motors 704A, 704B, the charge rollers 709A, 709B, the magnet rolls 722A, 722B, the first electrodes 741A, 741B, the second electrodes 742A, 742B, the third electrodes 743A, 743B, the first electrode power supplies 746A, 746B and the second electrode power supplies 747A, 747B has the same structure as the corresponding component in the sixth embodiment, except that, as to the charge rollers 709A, 709B, the first electrodes 741A, 741B, the second electrodes 742A, 742B, the third electrodes 743A, 743B, the first electrode power supplies 746A, 746B and the second electrode power supplies 747A, 747B, each of the components having the suffix “B” has a polar characteristic electrically opposite to that in the corresponding component having the suffix “A” or the corresponding component in the sixth embodiment.

An operation of the powder propellant-based space propulsion device 700 will be described below. Except that an operation for accelerating the powder propellant B in the second propulsion sub-device 700B is electrically opposite in polar characteristic, the operation of the powder propellant-based space propulsion device 700 including an operation for accelerating the powder propellant A in the first propulsion sub-device 700A is the same as that of the powder propellant-based space propulsion device 600 according to the sixth embodiment

The powder propellant 701A and the powder propellant 701B are electrostatically charged, respectively, to opposite electric polarities. Thus, a propulsive jet 708A to be released from the first propulsion sub-device 700A and a propulsive jet 708B to be released from the second propulsion sub-device 700B are electrostatically charged, respectively, to opposite electric polarities. In this case, the controller 712 controls the first and second propulsion sub-devices 700A, 700B in such a manner that the powder propellant 701A and the powder propellant 701B, or the propulsive jet 708A and the propulsive jet 708B are released therefrom at the same absolute value of electric charge per unit time. Further, the propulsive jet 708A and the propulsive jet 708B are released in the same downstream (expelling) direction, or released from the same side, respectively, in two directions each slightly inclined toward the other direction so as to subsequently intersect with one another, and then neutralized in a mixed manner. Subsequently, in the same manner as that in the powder propellant-based space propulsion device 100 according to the first embodiment, the controller 712 performs a control for returning respective areas for attractively holding the powder propellants 701A, 701B (powder-propellant holding areas) in the powder-propellant attracting drums 703A, 703b to corresponding attraction positions 710A, 710B in a repetitive manner.

### Eighth Embodiment

### Electrostatic Attraction, Laser Heating & Switching Between Plural Laser Devices

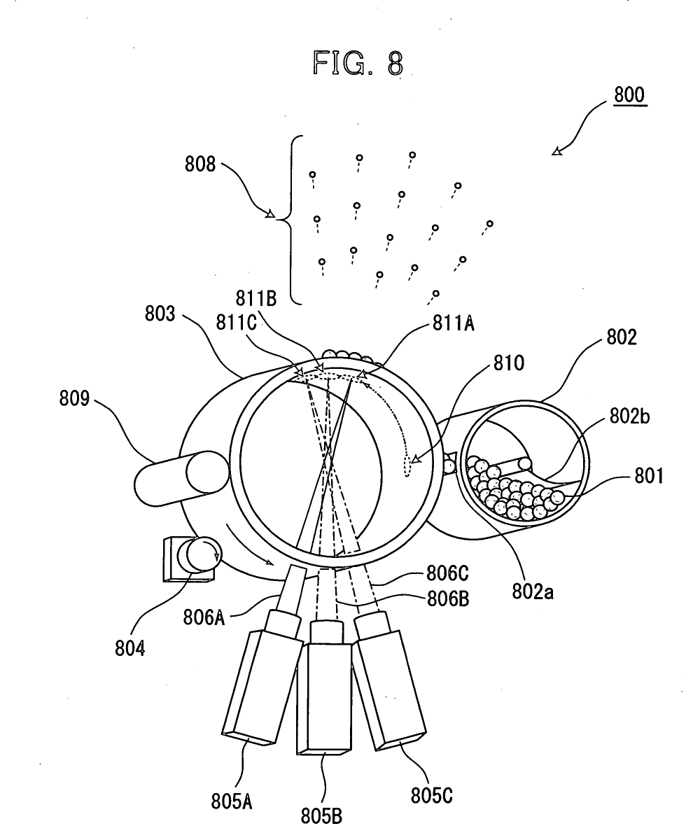

An eighth embodiment of the present invention will be described below. FIG. 8 is a schematic perspective view showing the structure of a powder propellant-based space propulsion device 800 according to the eighth embodiment of the present invention. In the powder propellant-based space propulsion device 800, a powder propellant is attracted by means of electrostatic attraction, and released by means of laser heating. Further, a plurality of laser beam oscillators are used in a switchable manner to change a direction of a propulsive jet. The structure of the powder propellant-based space propulsion device 800 will be firstly described. In FIG. 8, a component equivalent to that in other embodiments is defined by a reference numeral having the common tens and ones digits. The powder propellant-based space propulsion device 800 comprises a powder-propellant storage container 802, a powder-propellant attracting drum 803, a powder-propellant-attracting-drum rotating motor 804, a laser beam oscillator 805A, a laser beam oscillator 805B, a laser beam oscillator 805C and a charge roller 809. The powder-propellant storage container 802 includes a powder-propellant-storage-container opening 802a and an agitator 802b. The powder propellant-based space propulsion device 800 includes a housing (not shown) containing the above components while adequately maintaining a positional relationship therebetween. The powder propellant-based space propulsion device 800 further includes a controller (not shown) 812 for controlling respective operations of the agitator 802b, the powder-propellant-attracting-drum rotating motor 804, the laser beam oscillator 805A, the laser beam oscillator 805B and the laser beam oscillator 805C in association with each other. The powder propellant-based space propulsion device 800 is different from the powder propellant-based space propulsion device 100 according to the first embodiment, in that the powder propellant-based space propulsion device 800 includes the plurality of laser beam oscillators without using a component equivalent to the nozzle 107 in the first embodiment. In the powder propellant-based space propulsion device 800, a powder propellant 801 is used as a propellant.

As with the powder propellant 101 in the first embodiment, the powder propellant 801 is made of a material which is sublimatable by heating. Alternatively, the powder propellant 801 may be made of a self-heating material (one example of modification using a self-heating powder propellant). The powder propellant 801 is attracted to and attractively held on the powder-propellant attracting drum 803 by an electrostatic attraction.

Each of the powder-propellant storage container 802, the powder-propellant attracting drum 803, the powder-propellant-attracting-drum rotating motor 804, the charge roller 809 and the controller 812 has the same structure as the corresponding component in the first embodiment, except that that the controller 812 is electrically connected to each of the laser beam oscillator 805A, the laser beam oscillator 805B and the laser beam oscillator 805C to switch between these laser beam oscillators depending on an intended thrust direction.

Each of the laser beam oscillators 805A, 805B, 805C has the same structure as that of the laser beam oscillator 105 in the first embodiment. The laser beam oscillators 805A, 805B, 805C are disposed in such a manner as to irradiate, respectively, a plurality (three in this embodiment) of different release positions 811A, 811B, 811C on the powder-propellant attracting drum 803 with laser beams 806A, 806B, 806C from behind the release positions 811A, 811B, 811C. While three of the laser beam oscillators are used in this embodiment, the number of the laser beam oscillators may be arbitrarily selected. A component equivalent to the nozzle 107 in the powder propellant-based space propulsion device 100 according to the first embodiment is not essential to the powder propellant-based space propulsion device 800. When the nozzle is omitted in the powder propellant-based space propulsion device 800, an interval between the release positions 811A, 811B, 811C can be increased to allow the propulsive-jet direction or thrust direction to be largely changed. It is understood that a nozzle (not shown) 832 may be disposed in the same manner as the nozzle 107 in the powder propellant-based space propulsion device 100 according to the first embodiment. In this case, the nozzle 832 has an upstream open end disposed adjacent to the release positions 811A, 811B, 811C in such a manner as to surround all of the release positions 811A, 811B, 811C. Preferably, the upstream open end of the nozzle 832 is formed in an elongated shape or an oval shape along the release positions 811A, 811B, 811C, instead of a circular shape. Further, the nozzle 832 is preferably formed to have an elongated or oval shape in section. The nozzle 832 is designed to prevent a sublimated powder propellant 801 from spreading over surroundings and attaching on surrounding devices/structures as a re-solidified substance causing contamination thereof, and to adequately control a direction and speed of the propulsive jet 808 so as to efficiently obtain a thrust.

An operation of the powder propellant-based space propulsion device 800 will be described below. While the operation of the powder propellant-based space propulsion device 800 is partly the same as that of the powder propellant-based space propulsion device 100 according to the first embodiment, the mechanism and operation for releasing the powder propellant 801 are different from those in the powder propellant-based space propulsion device 100, as follows.

As with the powder-propellant attracting drum 103 in the first embodiment, a front surface of the powder-propellant attracting drum 803 is electrostatically charged in advance. In the attraction position 810, the powder-propellant attracting drum 803 rotated according to the rotation of the powder-propellant-attracting-drum rotating motor 804 attracts the powder propellant 801 fed by the agitator 802b under control of the controller 812, through the powder-propellant- storage-container opening 802a by an electrostatic attraction of the electric charge carried on the front surface of the powder-propellant attracting drum 803. Under control of the controller 812, the powder propellant 801 attractively held on the powder-propellant attracting drum 803 is transferred by the action of the powder-propellant-attracting-drum rotating motor 804, to either one of the release positions 811A, 811B, 811C depending on a desired expelling direction of the propulsive jet 808. The following description will be made on the assumption that the release positions 811A corresponds to a desired expelling direction of the propulsive jet 808.

The controller 812 detects that the powder propellant 801 has been transferred to the release position 811A corresponding to the desired propulsive-jet expelling direction, based on an output of a sensor or the number of rotations of the powder-propellant-attracting-drum rotating motor 804, and instructs the laser beam oscillator 805A to oscillate and emit the laser beam 806A so as to allow a area for attractively holding the powder propellant 801 (powder-propellant holding area) of the powder-propellant attracting drum 803 transferred to the release position 811A to be irradiated with the laser beam 806A from behind or the rear surface thereof. In the case where the powder propellant 801 is serially transferred, the laser beam 806A is serially emitted in synchronization therewith. The powder propellant 801 irradiated with the laser beam 806A absorbs energy of the laser beam 806A. Thus, the powder propellant 801 is heated and sublimated into a high-temperature/high-pressure gas. The resulting high-pressure gas receives the same pressure as that of itself perpendicular to and from the front surface of the powder-propellant attracting drum 803 at the release position 811A. Thus, the high-pressure gas is accelerated in the direction from which the pressure is received. Then, the accelerated high-pressure gas is guided by the nozzle 832 and expelled downward in the desired expelling direction or with a given angular range in an opening direction of the nozzle 832 as the propulsive jet 808 so as to produce a thrust as a counteraction against the propulsive jet 808. Depending on a desired expelling direction, the controller 812 continuously performs an operation of activating either one of the laser beam oscillators 805A, 805B, 805C to heat the powder propellant 801 located at a corresponding one of the release positions 811A, 811B, 811C so as to release and expel the propulsive jet 808 in the desired expelling direction. Subsequently, in the same manner as that in the powder propellant-based space propulsion device 100 according to the first embodiment, the controller 812 performs controls for returning the powder-propellant holding area of the powder-propellant attracting drum 803 to the attraction position 810 in a repetitive manner.

### Ninth Embodiment

### Electrostatic Attraction, Laser Heating & Variable Laser Beam Emitting Direction

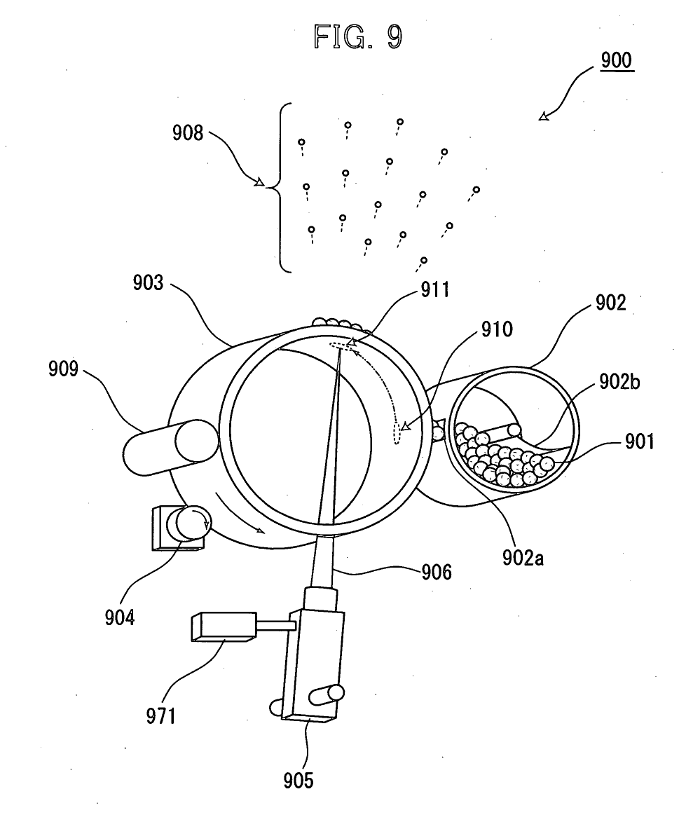

A ninth embodiment of the present invention will be described below. FIG. 9 is a schematic perspective view showing the structure of a powder propellant-based space propulsion device 900 according to the ninth embodiment of the present invention. In the powder propellant-based space propulsion device 900, a powder propellant is attracted by means of electrostatic attraction, and released by means of laser heating. Further, an emitting direction of a laser beam generated by a laser beam oscillator is varied to change a direction of a propulsive jet. The structure of the powder propellant-based space propulsion device 900 will be firstly described. In FIG. 9, a component equivalent to that in other embodiments is defined by a reference numeral having the common tens and ones digits. The powder propellant-based space propulsion device 900 comprises a powder-propellant storage container 902, a powder-propellant attracting drum 903, a powder-propellant-attracting-drum rotating motor 904, a laser beam oscillator 905, a charge roller 909 and a laser-beam-oscillator actuator 971. The powder-propellant storage container 902 includes a powder-propellant-storage-container opening 902a and an agitator 902b. The powder propellant-based space propulsion device 900 includes a housing (not shown) containing the above components while adequately maintaining a positional relationship therebetween. The powder propellant-based space propulsion device 900 further includes a controller (not shown) 912 for controlling respective operations of the agitator 902b, the powder-propellant-attracting-drum rotating motor 904, the laser beam oscillator 905 and the laser-beam-oscillator actuator 971 in association with each other. The powder propellant-based space propulsion device 900 is different from the powder propellant-based space propulsion device 100 according to the first embodiment, in that the powder propellant-based space propulsion device 900 includes the laser-beam-oscillator actuator 971 without using a component equivalent to the nozzle 107 in the first embodiment. In the powder propellant-based space propulsion device 900, a powder propellant 901 is used as a propellant.

As with the powder propellant 101 in the first embodiment, the powder propellant 901 is made of a material which is sublimatable by heating. Alternatively, the powder propellant 801 may be made of a self-heating material (one example of modification using a self-heating powder propellant). The powder propellant 901 is attracted to and attractively held on the powder-propellant attracting drum 903 by an electrostatic attraction.

Each of the powder-propellant storage container 902, the powder-propellant attracting drum 903, the powder-propellant-attracting-drum rotating motor 904, the charge roller 909 and the controller 912 has the same structure as the corresponding component in the first embodiment, except that that the controller 912 is additionally connected to the laser-beam-oscillator actuator 971.

The laser-beam-oscillator actuator 971 is provided as one example of means for variably changing a laser-beam emitting direction. Preferably, the laser-beam-oscillator actuator 971 has a movable element composed of a linear actuator or a rotary actuator. The controller 912 is operable, based on a desired propulsive-jet expelling direction, to determine a displacement value of the movable element of the laser-beam-oscillator actuator 971 and controllably move the movable element of the laser-beam-oscillator actuator 971 by the determined displacement value. Through this control, the laser-beam-oscillator actuator 971 changes a posture of the laser beam oscillator 905 to vary the emitting direction of the laser beam 906. The emitting direction of the laser beam 906 is varied depending on a desired expelling direction.

A component equivalent to the nozzle 107 in the powder propellant-based space propulsion device 100 according to the first embodiment is not essential to the powder propellant-based space propulsion device 900. When the nozzle is omitted in the powder propellant-based space propulsion device 900, a variable range of a release position 911 can be increased to allow a propulsive-jet direction or thrust direction to be largely changed. It is understood that a nozzle (not shown) 932 may be disposed in the same manner as the nozzle 107 in the powder propellant-based space propulsion device 100 according to the first embodiment. In this case, the nozzle 932 has an upstream open end disposed adjacent to the release position 911 in such a manner as to surround the entire variable range of the release position 911. Preferably, the upstream open end of the nozzle 932 is formed in an elongated shape or an oval shape along the variable range of the release position 911, instead of a circular shape. Further, the nozzle 932 is preferably formed to have an elongated or oval shape in section. The nozzle 932 is designed to prevent a sublimated powder propellant 901 from spreading over surroundings and attaching on surrounding devices/structures as a re-solidified substance causing contamination thereof, and to adequately control a direction and speed of the propulsive jet 908 so as to efficiently obtain a thrust.

An operation of the powder propellant-based space propulsion device 900 will be described below. While the operation of the powder propellant-based space propulsion device 900 is partly the same as that of the powder propellant-based space propulsion device 100 according to the first embodiment, the mechanism and operation for releasing the powder propellant 901 are different from those in the powder propellant-based space propulsion device 100, as follows.

As with the powder-propellant attracting drum 103 in the first embodiment, a front surface of the powder-propellant attracting drum 903 is electrostatically charged in advance. In an attraction position 910, the powder-propellant attracting drum 903 rotated according to the rotation of the powder-propellant-attracting-drum rotating motor 904 attracts the powder propellant 901 fed by the agitator 902b under control of the controller 912, through the powder-propellant-storage-container opening 902a by an electrostatic attraction of the electric charge carried on the front surface of the powder-propellant attracting drum 903. Under control of the controller 912, the powder propellant 901 attractively held on the powder-propellant attracting drum 903 is transferred by the action of the powder-propellant-attracting-drum rotating motor 904, to the release position 911 which corresponds to a laser-beam emitting direction of the laser beam oscillator 905 which is changed in posture by the laser-beam-oscillator actuator 971 in accordance with a desired propulsive-jet expelling direction.

The controller 912 detects that the powder propellant 901 has been transferred to the release position 911 based on an output of a sensor or the number of rotations of the powder-propellant-attracting-drum rotating motor 904, and instructs the laser beam oscillator 905 to oscillate and emit the laser beam 906 so as to allow a area for attractively holding the powder propellant 901 (powder-propellant holding area) of the powder-propellant attracting drum 903 transferred to the release position 911 to be irradiated with the laser beam 906 from behind or the rear surface thereof. In the case where the powder propellant 901 is serially transferred, the laser beam 906 is serially emitted in synchronization therewith. The powder propellant 901 irradiated with the laser beam 906 absorbs energy of the laser beam 906. Thus, the powder propellant 901 is heated and sublimated into a high-temperature/high-pressure gas. The resulting high-pressure gas receives the same pressure as that of itself perpendicular to and from the front surface of the powder-propellant attracting drum 903 at the release position 911. Thus, the high-pressure gas is accelerated in the direction from which the pressure is received. Then, the accelerated high-pressure gas is guided by the nozzle 932 and expelled downward in the desired expelling direction or with a given angular range in an opening direction of the nozzle 932 as the propulsive jet 908 so as to produce a thrust as a counteraction against the propulsive jet 908. Depending on a desired expelling direction, the controller 912 continuously performs an operation of activating the laser-beam-oscillator actuator 971 to change the posture of the laser beam oscillator 905 so as to release and expel the propulsive jet 908 in the desired expelling direction. Subsequently, in the same manner as that in the powder propellant-based space propulsion device 100 according to the first embodiment, the controller 912 performs controls for returning the powder-propellant holding area of the powder-propellant attracting drum 903 to the attraction position 910 in a repetitive manner.

Various embodiments of the present invention have been described. These embodiments include various types of structural/functional elements as shown in the following summary. In the powder propellant-based space propulsion device of the present invention, any of these structural/functional elements may be combined together to the extent possible, as follows.

I. Electrical Characteristics of Powder Propellant

(1) Electrically insulating material

(2) Electrically conductive material

Either one of these materials may be freely selected.

II. Magnetic Characteristic of Powder Propellant

(1) Non-magnetic material

(2) Ferromagnetic material

The “non-magnetic material” may be used in the following V-(1) “electrostatic attraction”, V-(3) “electrostatic/magnetic combinational attraction”, and VI-(2) “use of powder-propellant carrier”.

The “ferromagnetic material” may be used in the following V-(2) “magnetic attraction”, V-(3) “electrostatic/magnetic combinational attraction”, and VI-(2) “nonuse of powder-propellant carrier”.

III. Chemical Characteristics of Powder Propellant

(1) Material which is sublimatable by heating (sublimatable material)

(2) Material which is sublimatable by heating and ionizable by discharge (sublimatable/ionizable material)

(3) Self-heating material

(4) Material having no chemically special property (non-special property material)

The “sublimatable material” may be used in the following VIII-(1) “laser heating”, and VIII-(2) “discharge heating”.

The “sublimatable/ionizable material” may be used in the following VIII-(5) “discharge/electromagnetic acceleration”.

The “self-heating material” may be used in the following VIII-(3) “laser ignition” and VIII-(4) “discharge ignition”.

The “non-special property material” may be used in the following VIII-(6) “electrostatic acceleration”.

IV. Shape of Powder-propellant Attracting Drum

(1) Cylindrical shape

(2) Partially cylindrical shape

(3) Planar shape

Either one of these shapes may be freely selected.

V. Means for Feeding the Powder-propellant to the Powder-propellant Attracting Drum and Means for Transferring the Powder-propellant on the Power Powder-propellant Attracting Drum

(1) Electrostatic attraction

(2) Magnetic attraction

(3) Electrostatic/magnetic combinational attraction

These means may be used based on the relation set forth in the Section II.

VI. Use/Nonuse of Powder-propellant Carrier in Electrostatic/Magnetic Combinational Attraction

(1) Nonuse of powder-propellant carrier

(2) Use of powder-propellant carrier

These usages may be used based on the relation set forth in the Section II.

VII. Means for Electrostatically Charging Powder-propellant Attracting Drum in Electrostatic Attraction or Electrostatic/Magnetic Combinational Attraction

(1) Charge roller

(2) Charge electrode

Either one of these means may be freely selected.

VIII. Means for Accelerating Powder Propellant

(1) Laser heating

(2) Discharge heating

(3) Laser Ignition

(4) Discharge Ignition

(5) Discharge/electromagnetic acceleration

What is claimed is:

1. A powder propellant-based space propulsion device comprising:
a powder-propellant storage container having an inner space for storing a powder propellant and an opening for feeding the powder propellant to the outside therethrough;
a powder-propellant attracting surface for attracting the powder propellant in said powder-propellant storage container thereto through said opening and attractively holding said attracted powder propellant thereon;
powder-propellant transfer means for moving said powder-propellant attracting surface having a area for attractively holding the powder propellant thereon so as to transfer the powder propellant attractively held on said area to a release position for releasing said powder propellant; and
propulsive-energy supply means for energizing the powder propellant transferred to said release position to release said powder propellant from said powder-propellant attracting surface, toward a downstream side thereof as a propulsive jet, while accelerating the powder propellant in a direction approximately perpendicular to said powder-propellant attracting surface at said release position,
wherein said powder-propellant transfer means is designed to move said powder-propellant attracting surface in such a manner that said area for attractively holding the powder propellant is returned to a position adjacent to the opening of said powder-propellant storage container in a repetitive manner.

2. The powder propellant-based space propulsion device as defined in claim 1, which further comprises:
powder-propellant charging means for electrostatically charging the powder propellant to have a positive electric charge; and
a neutralizer disposed on a downstream side of said release position and designed to emit an electron for neutralizing the electric charge of the powder propellant released as the
(6) Electrostatic acceleration
These means may be used based on the relation set forth in the Section III.
IX. Propulsion-jet expelling direction in laser heating or laser ignition
(1) Single expelling direction using single laser beam oscillator
(2) Variable expelling direction based on switching between plural laser beam oscillators
(3) Variable expelling direction based on single laser beam oscillator with variable emitting direction function
Either one of the means may be freely selected.
X. Use/Nonuse of Neutralizer in electrostatic acceleration of powder propellant
(1) Single propulsion device using neutralizer
(2) Plural propulsion devices simultaneously expelling positively and negatively charged particles without using a neutralizer
Either one of these usages may be freely selected.
such a manner that respective propulsive jets of said first and second powder propellant-based space propulsion sub-devices are oriented in substantially the same direction;
the propulsive-energy supply means included in said first powder propellant-based space propulsion sub-device is composed of a first accelerating electrode designed to apply a first accelerating electric field to a powder-propellant accelerating zone starting from the release position, so as to allow the powder propellant positively charged by said first powder-propellant charging means to be accelerated toward a downstream side of said first accelerating electrode by an electrostatic attraction of said first accelerating electric field;
the propulsive-energy supply means included in said second powder propellant-based space propulsion sub-device is composed of a second accelerating electrode designed to apply a second accelerating electric field to a powder-propellant accelerating zone starting from the release position, so as to allow the powder propellant negatively charged by said second powder-propellant charging means to be accelerated toward a downstream side of said second accelerating electrode by an electrostatic attraction of said second accelerating electric field; and
said first and second powder propellant-based space propulsion sub-devices are designed such that said positively-charged powder propellant of said first powder propellant-based space propulsion sub-device and said negatively-charged powder propellant of said second powder propellant-based space propulsion sub-device are released therefrom at the same absolute value of electric charge per unit time, and then neutralized in a mixed manner.

3. The powder propellant-based space propulsion device as defined in claim 1, which further comprises a tube-shaped jet member having an upstream end for introducing the propulsive jet generated at said release position and a downstream end for expelling the introduced propulsive jet, said upstream end of said jet member being disposed adjacent to said powder-propellant attracting surface, wherein said release position is defined within a area of said powder-propellant attracting surface surrounded by said upstream end of said jet propulsive jet,
wherein said propulsive-energy supply means is composed of an accelerating electrode designed to apply an accelerating electric field to a powder-propellant accelerating zone starting from said release position, so as to allow the powder propellant electrostatically charged by said powder-propellant charging means to be accelerated toward the downstream side by an electrostatic attraction of said accelerating electric field.

4. The powder propellant-based space propulsion device as defined in claim 2, wherein said accelerating electrode serving as said propulsive-energy supply means includes:
a first electrode disposed adjacent to the back side of said powder-propellant attracting surface and designed to be applied with a potential having the same polarity as that of the electric charge of said charged powder propellant; and
a lattice-shaped second electrode disposed on the downstream side of said release position and designed to be applied with a potential having an opposite polarity to that of said first electrode.

5. A powder propellant-based space propulsion device comprising a first powder propellant-based space propulsion sub-device and a second powder propellant-based space propulsion sub-device, each of which incorporates the powder propellant-based space propulsion device as defined in claim 1, wherein:
said first powder propellant-based space propulsion sub-device includes first powder-propellant charging means for electrostatically charging the powder propellant to have a positive electric charge;
said second powder propellant-based space propulsion sub-device includes second powder-propellant charging means for electrostatically charging the powder propellant to have a negative electric charge;
said first powder propellant-based space propulsion sub-device and said second powder propellant-based space propulsion sub-device are disposed adjacent to one another in member.

6. The powder propellant-based space propulsion device as defined in claim 5, wherein said jet member is formed as a divergent nozzle.

7. The powder propellant-based space propulsion device as defined in claim 1, wherein said powder-propellant attracting surface is made of an electrically insulating material, wherein said powder propellant-based space propulsion device further comprises powder-propellant-attracting-surface charging means for electrostatically charging said powder-propellant attracting surface, said powder-propellant-attracting-surface charging means being operable to allow the powder propellant to be attracted to said powder-propellant attracting surface through said opening and held on said powder-propellant attracting surface by an electrostatic attraction.

8. The powder propellant-based space propulsion device as defined in claim 7, wherein said powder-propellant-attracting-surface charging means is composed of a charge roller disposed in contact with said powder-propellant attracting surface.

9. The powder propellant-based space propulsion device as defined in claim 1, wherein said powder-propellant attracting surface is made of a ferromagnetic material, wherein said powder propellant-based space propulsion device further comprises an attracting magnet for providing a magnetic field at least in a area ranging from a position where the powder propellant is to be attracted to said powder-propellant attracting surface, to said release position, said attracting magnet being operable to allow the powder propellant to be attracted to said powder-propellant attracting surface through said opening and held on said powder-propellant attracting surface by a magnetic attraction of said magnetic field.

10. The powder propellant-based space propulsion device as defined in claim 1, wherein:
said powder-propellant attracting surface is made of an electrically insulating material: and
said powder propellant is made of a ferromagnetic material,
wherein said powder propellant-based space propulsion device further comprises:
a magnetic roller designed to have a magnetic field on a surface thereof and disposed between said opening and said powder-propellant attracting surface and in adjacent relation to each of said opening and said powder-propellant attracting surface; and
powder-propellant-attracting-surface charging means for electrostatically charging said powder-propellant attracting surface,
wherein:
said magnetic roller is operable to attract the powder propellant to the surface thereof through said opening and hold said powder propellant by a magnetic force of said magnetic field;
said magnetic roller is operable to be rotated so as to transfer said held powder propellant to a position adjacent to said powder-propellant attracting surface; and
said powder-propellant-attracting-surface charging means is operable to allow said transferred powder propellant to be attracted from said magnetic roller to said powder-propellant attracting surface and held on said powder-propellant attracting surface by an electrostatic attraction.

11. The powder propellant-based space propulsion device as defined in claim 7, wherein said powder-propellant-attracting-surface charging means is composed of a charge roller disposed in contact with said powder-propellant attracting surface.

12. The powder propellant-based space propulsion device as defined in claim 1, wherein:
said powder propellant is made of a material which is sublimatable by heating;
at least a part of said powder-propellant attracting surface is formed as a transparent portion made of a transparent material; and
said propulsive-energy supply means is composed of a laser beam oscillator, said laser beam oscillator being designed to generate a laser beam and irradiate the powder propellant transferred to said release position, with the laser beam from behind said powder-propellant attracting surface through said transparent portion to heatingly sublimate and release said powder propellant.

13. The powder propellant-based space propulsion device as defined in claim 5, wherein:
said powder propellant is made of a material which is sublimatable by heating; and
said propulsive-energy supply means is composed of a pair of main-discharge electrodes disposed inside said jet member and in opposed relation to one another, and a main-discharge power supply, said main-discharge power supply being designed to generate a high voltage and apply the high voltage between said main-discharge electrodes so as to produce a main discharge to heatingly sublimate and release the powder propellant located adjacent to said main-discharge electrodes.

14. The powder propellant-based space propulsion device as defined in claim 13, which further comprises:
an igniter including a triggering-discharge electrode designed to produce a triggering discharge for initiating a main discharge between said main-discharge electrodes and disposed inside said jet member and in adjacent relation to the powder-propellant attracting surface; and
a triggering-discharge power supply for said triggering discharge,
wherein said main-discharge electrodes are composed of a pair of rod-shaped electrodes disposed in opposed relation to one another in a divergent arrangement,
wherein:
said igniter is operable to produce the triggering discharge so as to generate the main discharge between said main-discharge electrodes; and
said main-discharge electrodes are operable to sublimate the powder propellant by said main discharge generated therebetween while ionizing at least a part of said sublimated powder propellant, and allow said ionized powder propellant to be expelled toward the downstream side of said jet member based on an electromagnetic interaction between a current supplied to said ionized powder propellant by said main discharge and a magnetic field generated by said main discharge.

15. The powder propellant-based space propulsion device as defined in claim 13, wherein said main-discharge electrodes constitute at least a part of said jet member.

16. The powder propellant-based space propulsion device as defined in claim 1, wherein:
said powder propellant is made of a self-heating material which is ignitable by heating;
at least a part of said powder-propellant attracting surface is formed as a transparent portion made of a transparent material; and
said propulsive-energy supply means is composed of a laser beam oscillator, said laser beam oscillator being designed to generate a laser beam and irradiate the powder propellant transferred to said release position, with the laser beam from behind said powder-propellant attracting surface through said transparent portion to heatingly ignite and release said powder propellant.

17. The powder propellant-based space propulsion device as defined in claim 5, wherein:
said powder propellant is made of a self-heating material which is ignitable by heating; and
said propulsive-energy supply means is composed of a pair of main-discharge electrodes disposed inside said jet member and in opposed relation to one another, and a main discharge power supply, said main discharge power supply being designed to generate a high voltage and apply the high voltage between said main-discharge electrodes so as to produce a main discharge to heatingly ignite and release the powder propellant located adjacent to said main-discharge electrodes.

18. The powder propellant-based space propulsion device as defined in claim 17, wherein said main-discharge electrodes constitute at least a part of said jet member.

19. The powder propellant-based space propulsion device as defined in claim 1, wherein:
said powder-propellant attracting surface is formed in a cylindrical shape; and
said powder-propellant transfer means is designed to rotate said powder-propellant attracting surface about an axis of said cylindrical shape so as to transfer the powder propellant to said release position.

20. The powder propellant-based space propulsion device as defined in claim 1, wherein:
said powder-propellant attracting surface is formed in a partially-cylindrical shape having a sector-shaped bottom; and
said powder-propellant transfer means is designed to swing said powder-propellant attracting surface about an axis of said partially-cylindrical shape so as to transfer the powder propellant to said release position.

21. The powder propellant-based space propulsion device as defined in claim 1, wherein:
said powder-propellant attracting surface is formed in a planar shape; and
said powder-propellant transfer means is designed to linearly reciprocate said powder-propellant attracting surface so as to transfer the powder propellant to said release position.

22. The powder propellant-based space propulsion device as defined in claim 1, wherein said powder-propellant storage container includes powder-propellant agitating means for agitating the powder propellant stored in said powder-propellant storage container.

23. The powder propellant-based space propulsion device as defined in claim 1, wherein:
said powder propellant is made of a material which is sublimatable by heating;
said powder-propellant attracting surface is formed in a cylindrical shape or in a partially-cylindrical shape having a sector-shaped bottom, at least a part of said powder-propellant attracting surface being formed as a transparent portion made of a transparent material; and
said propulsive-energy supply means is composed of a plurality of laser beam oscillators each designed to irradiate a corresponding one of a plurality of different positions of said powder-propellant attracting surface with a laser beam,
wherein:
plural number of said release positions are defined, respectively, at said plurality of different positions to be irradiated with the laser beam; and
each of said laser beam oscillators serving as said propulsive-energy supply means is designed to generate a laser beam, and irradiate the powder propellant transferred to a corresponding one of said release positions, with the laser beam from behind said powder-propellant attracting surface through said transparent portion so as to heatingly sublimate and release said powder propellant.

24. The powder propellant-based space propulsion device as defined in claim 1, wherein:
said powder propellant is made of a self-heating material which is ignitable by heating;
said powder-propellant attracting surface is formed in a cylindrical shape or in a partially-cylindrical shape having a sector-shaped bottom, at least a part of said powder-propellant attracting surface being formed as a transparent portion made of a transparent material; and
said propulsive-energy supply means is composed of a plurality of laser beam oscillators each designed to irradiate a corresponding one of a plurality of different positions of said powder-propellant attracting surface with a laser beam,
wherein:
plural number of said release positions are defined, respectively, at said plurality of different positions to be irradiated with the laser beam; and
each of said laser beam oscillators serving as said propulsive-energy supply means is designed to generate a laser beam, and irradiate the powder propellant transferred to a corresponding one of said release positions, with the laser beam from behind said powder-propellant attracting surface through said transparent portion to heatingly ignite and release said powder propellant.

25. The powder propellant-based space propulsion device as defined in claim 1, wherein:
said powder propellant is made of a material which is sublimatable by heating;
said powder-propellant attracting surface is formed in a cylindrical shape or in a partially-cylindrical shape having a sector-shaped bottom, at least a part of said powder-propellant attracting surface being formed as a transparent portion made of a transparent material; and
said propulsive-energy supply means is composed of a laser beam oscillator including laser-beam emitting direction changing means operable to change an emitting direction of a laser beam,
wherein:
said release position is defined in a given range corresponding to a area of said powder-propellant attracting surface to be irradiated with the laser beam; and
said laser beam oscillator serving as said propulsive-energy supply means is designed to generate a laser beam, and irradiate the powder propellant transferred to the release position defined in said range, with the laser beam from behind said powder-propellant attracting surface through said transparent portion so as to heatingly sublimate and release said powder propellant.

26. The powder propellant-based space propulsion device as defined in claim 1, wherein:
said powder propellant is made of a self-heating material which is ignitable by heating;
said powder-propellant attracting surface is formed in a cylindrical shape or in a partially-cylindrical shape having a sector-shaped bottom, at least a part of said powder-propellant attracting surface being formed as a transparent portion made of a transparent material; and
said propulsive-energy supply means is composed of a laser beam oscillator including laser-beam emitting direction changing means operable to change an emitting direction of a laser beam,
wherein:
said release position is defined in a given range corresponding to a area of said powder-propellant attracting surface to be irradiated with the laser beam; and
said laser beam oscillator serving as said propulsive-energy supply means is designed to generate a laser beam, and irradiate the powder propellant transferred to the release position defined in said range, with the laser beam from behind said powder-propellant attracting surface through said transparent portion so as to heatingly ignite and release said powder propellant.
